(19) United States
(12) Patent Application Publication
(10) Pub. No.: US 2026/0368259 A1
(43) Pub. Date: Nov. 19, 2026

(54) METHODS, SYSTEMS, AND APPARATUSES FOR VALIDATING THE DISCOVERABILITY OF CONTENT

(71) Applicant: Comcast Cable Communications, LLC, Philadelphia, PA (US)

(72) Inventors: Kishorekumar SundaraRajan, Washington, DC (US); Adeep Hande, Washington, DC (US)

(21) Appl. No.: 19/665,345

(22) Filed: May 1, 2026

Related U.S. Application Data
(60) Provisional application No. 63/806,308, filed on May 15, 2025.

(51) Int. Cl. G06F 16/9035; G06F 16/907

(52) U.S. Cl. CPC G06F 16/9035; G06F 16/907

(57) ABSTRACT

Described herein are methods, systems, and apparatuses for validating the discoverability of content. A user search for a target content item may be conducted by generating a plurality of search queries. The plurality of search queries may then be provided to a search database of content items to determine if the target content item will be identified in the search results associated with the search query or will be ranked at a desired level within the search results associated with the search query. If the target content item is not identified in the search results associated with the search query or ranked or positioned at a desired level within the search results associated with the search query, remedial actions may be taken to ensure the content item will be identified or ranked or positioned higher when the particular search query is subsequently used.

### CROSS-REFERENCE TO RELATED PATENT APPLICATIONS

This application claims priority to and the benefit of U.S. Provisional Patent Application No. 63/806,308, filed May 15, 2025, the entire contents of which are hereby incorporated herein by reference in its entirety.

### BACKGROUND

With the rapidly changing landscape of providing and receiving content, such as television shows, sports, movies, etc., it is important for users to be able to discover content items, as well as major events. To discover said content, users may rely on voice and/or text search queries of a content database. Content providers may want to validate that upcoming digital content is easily discoverable by the users. Historically, the process of determining discoverability of content items is done with manual editorial workflows that involve several hands-on fixes and overrides. For example, data collection is often a manual process that involves outsourcing information from external metadata systems and manually testing against a platform to verify a content item is discoverable.

### SUMMARY

It is to be understood that both the following general description and the following detailed description are exemplary and explanatory only and are not restrictive. This summary is not intended to identify critical or essential features, but merely to summarize certain features and variations. Other details and features will be described in the sections that follow.

Described herein are methods, systems, and apparatuses for validating the discoverability of content. In some examples, the present methods, systems, and apparatuses may be used for enhancing the discoverability of content items. A user search for a new or upcoming content item may be conducted. Search queries may be computer-generated queries which mimic or replicate historical user-generated queries. For example, search queries directed to a target content item may be generated and run in a simulation environment to determine if the target content item will be identified in the search results associated with the search query or will be ranked at a desired level within the search results associated with the search query. If the target content item does not appear in the search results associated with the search query, remedial actions may be taken to ensure the content item will be identified or ranked or positioned higher when the particularly search query is subsequently used. Other examples are possible as well.

### BRIEF DESCRIPTION OF THE DRAWINGS

The accompanying drawings, which are incorporated in and constitute a part of this specification, together with the description, serve to explain the principles of the present methods, systems, and apparatuses:

FIG. 1 shows an example system;

FIG. 2 shows an example query generator system;

FIG. 3 shows an example process;

FIG. 4 shows an example process;

FIG. 5 shows an example process;

FIG. 6 shows a flowchart for an example method;

FIG. 7 shows a flowchart for an example method;

FIG. 8 shows a flowchart for an example method;

FIG. 9 shows a flowchart for an example method;

FIG. 10 shows a flowchart for an example method;

FIG. 11 shows a flowchart for an example method;

FIG. 12 shows a flowchart for an example method; and

FIG. 13 shows an example computing device and system.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers, or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memristors, Non-Volatile Random Access Memory (NVRAM), flash memory, or a combination thereof.

Throughout this application, reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general-purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

“Content items,” as the phrase is used herein, may also be referred to as “content,” “content data,” “content information,” “content asset,” “multimedia asset data file,” or simply “data” or “information”. Content items may be any information or data that may be licensed to one or more individuals (or other entities, such as business or group). Content may be electronic representations of video, audio, text, and/or graphics, which may be but is not limited to electronic representations of videos, movies, or other multimedia, which may be but is not limited to data files adhering to H.264/MPEG-AVC, H.265/MPEG-HEVC, H.266/MPEG-VVC, MPEG-5 EVC, MPEG-5 LCEVC, AV1, MPEG2, MPEG, MPEG4 UHD, SDR, HDR, 4k, Adobe® Flash® Video (.FLV), ITU-T H.261, ITU-T H.262 (MPEG-2 video), ITU-T H.263, ITU-T H.264 (MPEG-4 AVC), ITU-T H.265 (MPEG HEVC), ITU-T H.266 (MPEG VVC) or some other video file format, whether such format is presently known or developed in the future. The content items described herein may be electronic representations of music, spoken words, or other audio, which may be but is not limited to data files adhering to MPEG-1 audio, MPEG-2 audio, MPEG-2 and MPEG-4 advanced audio coding, MPEG-H, AC-3 (Dolby Digital), E-AC-3 (Dolby Digital Plus), AC-4, Dolby Atmos®, DTS®, and/or any other format configured to store electronic audio, whether such format is presently known or developed in the future. Content items may be any combination of the above-described formats.

“Consuming content” or the “consumption of content,” as those phrases are used herein, may also be referred to as “accessing” content, “providing” content, “viewing” content, “listening” to content, “rendering” content, or “playing” content, among other things. In some cases, the particular term utilized may be dependent on the context in which it is used. Consuming video may also be referred to as viewing or playing the video. Consuming audio may also be referred to as listening to or playing the audio. This detailed description may refer to a given entity performing some action. It should be understood that this language may in some cases mean that a system (e.g., a computer) owned and/or controlled by the given entity is actually performing the action.

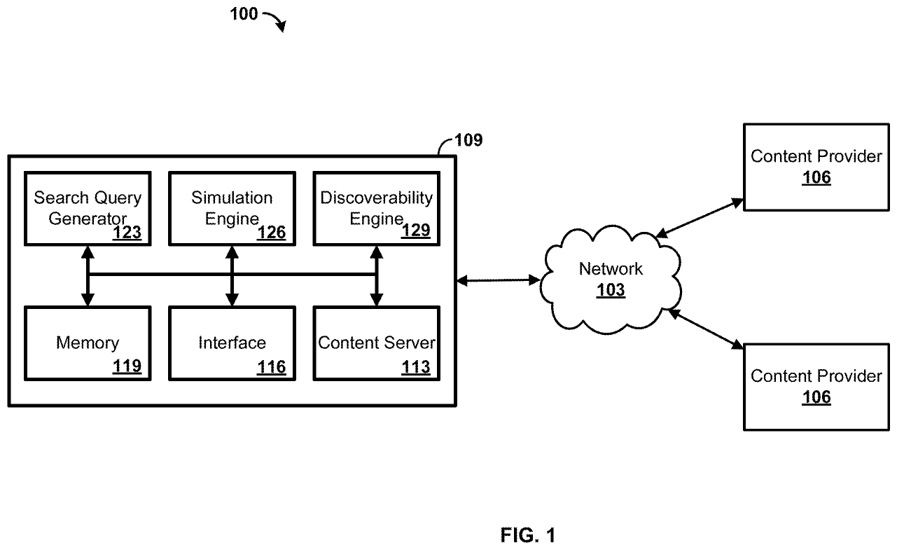

FIG. 1 shows an example system 100 that may be used for implementing various aspects of determining the discoverability of content items. The example system 100 may be automated evaluation tool configured to predict how easily a content item will or may be discovered when it is searched by users in the future. A content item may be considered discoverable when the user readily finds the content item via voice or text searches. For example, a content item may be discoverable when a search yields the content item as part of the top k (e.g., 10, 5, 3, etc.) search results, as the first search result, or as a visible result on a search landing page. The system 100 may determine available and soon to be available content items and generate search queries and synonyms for those content items that mimic or approximate how users would phrase their search queries. A search query may comprise a computer-generated or tester-generated search query directed to a particular target content item which mimics or approximates a user-generated search query for the target content item. The system 100 may determine whether one or more search requests, structured in the form of a plurality of different search queries, will lead to positive or negative results. For example, a search query may yield positive results when the search query produces the target content item as the first search result in a search. Similarly, as an example, a search query may yield negative results when the search query fails to produce the target content item as the first search result in a search. The system 100 may simulate content item discoverability to determine whether the content item search interface for the content platform is populating the content item search query results in a desired manner. For example, the system 100 may determine discoverability based on a likelihood of a search query being received or input at the content item search interface for the particular content platform. For example, the system 100 may determine discoverability based on a likelihood of the search query being successfully interpreted by the content item search interface for the particular content provider. The system 100 may allow for the implementation of appropriate changes so that the content item will be displayed on a first page of search results in the content item search interface or will be moved higher (such as to the top spot) in the listing of search results in the content item search interface, so that users of a content platform may more easily find their intended content items. These and other examples are discussed herein.

The system 100 of FIG. 1 may employ various forms of machine learning techniques, and other methods described herein to overcome issues of human error, tester bias, and timeliness. The system 100 may comprise a search query generation module that mimics users' behaviors to generate diverse sets of content item search queries that are similar to user-generated search queries for content items. For example, the system 100 may use a large language model (LLM) to generate search queries which may be the same or similar to user-generated search queries that users may provide to search for a particular content item. For example, by providing an LLM with metadata about a content item or a plurality of content items, as well as historical user-generated search queries provided by users in previous searches for the same or different content items, the LLM can predict which search queries users will most likely provide to the content item search interface for a particular content provider or platform while searching for the content item. The use of computer-generated search queries may reduce tester bias and ensure that a broader range of queries is tested.

Additionally, the system 100 may use the search queries to conduct simulations of the content item search interface for the particular content provider and/or platform. The system 100 may operate independently of internal search results' metadata. For example, the system 100 may comprise a simulation environment representing a content item search interface for a content platform having the new or existing content items that are or may soon be available to selection and viewing by a user. The simulation environment may be representative of the content item search interface for the platform from a user's perspective, without access to metadata or back-end processes that a developer would be able to access. The system 100 may enter the search queries into the simulation environment to simulate a user search experience for the content item. In response to the input of a search query, the simulation environment may perform a search of the platform's content item database(s) with the additional content items. The results of the search results of one or a plurality of content items may be presented to the system 100 in the same manner that the search results would be presented to a user who conducted the search. For example, in the case of a television show as the desired content item to receive in a search result, the system 100 may use a search query to produce search results of content items that are output on or otherwise presented on a search landing page from a user's point of view. Based on the content items listed on the search results landing page, the system 100 may assess whether the desired content item (e.g., the television show) is discoverable and to what extent. Thus, in analyzing the content items presented in the search results of the search, the system 100 may interpret the search results as the user would see them, and not falsely inflate the search results due to additional data or the presentation of such data. The discoverability assessment may be used in determining which remedial action, if any, may be made in order to make the target content item more discoverable.

The system 100 may comprise a variety of interconnected components that work together to determine the discoverability of a content item. The system 100 may comprise a plurality of computing devices/entities in communication via a network 103. The network 103 may be an optical fiber network, a coaxial cable network, a hybrid fiber-coaxial network, a wireless network, a satellite system, a direct broadcast system, an Ethernet network, a high-definition multimedia interface network, a Universal Serial Bus (USB) network, or any combination thereof. Data may be sent on the network 103 via a variety of transmission paths, including wireless paths (e.g., satellite paths, Wi-Fi paths, cellular paths, etc.) and terrestrial paths (e.g., wired paths, a direct feed source via a direct line, etc.). The network 103 may comprise public networks, private networks, wide area networks (e.g., Internet), local area networks, and/or the like. The network 103 may comprise a content access network, content distribution network, and/or the like. The network 103 may be configured to provide content (e.g., content items) from a variety of sources using a variety of network paths, protocols, devices, and/or the like. The content delivery network and/or content access network may be managed (e.g., deployed, serviced) by a content provider, a service provider, and/or the like. The network 103 may deliver content items from a source(s) to a user device(s).

The system 100 may comprise one or more content providers 106. Each content provider 106 may comprise one or more servers or other computing devices that provide content items over the network 103. The content provider(s) 106 may comprise a television broadcast company, a movie studio, a web site or service, an audio source, a video-on-demand server, a streaming service, such as Netflix®, Hulu®, etc., and/or the like. The content provider(s) 106 may create, produce, and/or distribute, etc., content that is embodied in one or more multimedia asset data files (e.g., content assets). The content provider(s) 106 may provide content (e.g., video, audio, games, applications, data) and/or content items (e.g., video, streaming content, movies, shows/programs, etc.) to user devices or other computing devices. The content provider(s) 106 may provide streaming media, such as live content, on-demand content (e.g., video-on-demand), content recordings, and/or the like. The content provider(s) 106 may comprise one or multiple computers configured to store content data (e.g., a plurality of content items, content item metadata, historical content item metadata, etc.). Multiple content providers 106 may communicate with the computing device 109 via the through the network 103. The content provider(s) 106 may be managed by third-party content providers, service providers, online content providers, over-the-top content providers, and/or the like. A content item may be provided via a subscription, by individual item purchase or rental, and/or the like. The content provider(s) 106 may be configured to provide content items via the network 103. Content items may be accessed by user devices via content platforms or applications, such as mobile applications, television applications, set-top box applications, gaming device applications, and/or the like. A content platform may be a custom application (e.g., by a content provider, for a specific device), a general content browser (e.g., a web browser), an electronic program guide, and/or the like. The content provider(s) 106 may provide uncompressed content items, such as raw video data, comprising one or more portions (e.g., frames/slices, groups of pictures (GOP), coding units (CU), coding tree units (CTU), etc.). It should be noted that although two content providers 106 are shown in FIG. 1, this is not to be considered limiting. In accordance with the described techniques, the system 100 may comprise one or more content providers 106, each of which may share any number of source streams.

The content server 113 may be one or more computing devices or servers in the computing device 109. The content server 113 may be configured to receive content from the content provider(s) 106. The content server 113 may be configured to receive requests for content, such as content items/streams. The content server 113 may identify a location or content provider 106 of a requested content item and provide the content item—or a portion thereof—to a device requesting the content, such as a computing device, an application, or the like. The content server 113 may be configured to provide a communication session with a requesting device or application based on HTTP, FTP, or other protocols. The content server 113 may be one of a plurality of content servers distributed across the system 100. The content server 113 may be a video hosting and streaming server. The content server 113 may comprise software to validate user identities and entitlements, to locate and retrieve requested content, to encrypt the content, and to initiate delivery (e.g., streaming or downloading) of the content to the requesting user(s) and/or device(s).

A request for a content stream/item from the computing device 109 may be directed to the content server 113. The content server 113 may be configured to deliver content streams/items to the computing device 109 in a specific format requested by the computing device 109. The content server 113 may be configured to provide the computing device 109 with a manifest file (e.g., or other index file describing portions of the content) corresponding to a content stream/item. The content server 113 may be configured to provide streaming content (e.g., unicast, multicast) to the computing device 109. The content server 113 may be configured to provide a file transfer and/or the like to the computing device 109. The content server 113 may cache or otherwise store content (e.g., frequently requested content) to enable faster delivery of content items to users. The content server 113 may receive a request for a content item, such as a request for high-resolution video and/or the like. The content server 113 may receive the request for the content item from the computing device 109.

The system 100 may further comprise an interface 116. The interface 116 may be, for example, but is not limited to, one or more buses or other wired or wireless connections, as is known in the art. The interface 116 may have additional elements, which are omitted for simplicity, such as controllers, buffers (caches), drivers, repeaters, and receivers, to enable communications. Further, the interface 116 may comprise address, control, and/or data connections to enable appropriate communications among the aforementioned components.

The computing device 109 may comprise memory 119. The memory 119 may comprise non-transitory computer-readable storage media, such as one or more data storage devices that may be accessed by the computing device 109, and that provide persistent storage of data and executable instructions (e.g., software applications, programs, functions, and the like). Examples of computer-readable storage media comprise volatile memory and non-volatile memory, fixed and removable media devices, and any suitable memory device or electronic data storage that maintains data for computing device access. The memory 119 may comprise any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the memory 119 may incorporate electronic, magnetic, optical, and/or other types of storage media. Note that the memory 119 may have a distributed architecture, where various components are situated remote from one another, but may be accessed by the processor. The memory 119 provides storage of data and various software applications, such as an operating system that is maintained as a software application with the computer-readable storage media and executed by a processor. For example, the memory 119 may comprise metadata for one or more upcoming content items, metadata for past content items, historical user-generated search queries, and/or various other data.

The software in the memory 119 may comprise one or more software programs, each of which comprises an ordered listing of executable instructions for implementing logical functions. In the example of FIG. 1, the software in the memory 119 of the computing device 109 may comprise a suitable operating system (O/S). The operating system essentially controls the execution of other computer programs and provides scheduling, input-output control, file and data management, memory management, and communication control and related services.

The system 100 may comprise a search query generator 123. The search query generator 123 may comprise a large language model (LLM) which is capable of producing search queries for content items that resemble user-generated search queries for content items. For example, the search query generator 123 may comprise a transformer-based model, an autoencoder-based model, an autoregressive model, a variational autoencoder, a recurrent neural network-based model, a hybrid model, etc. The search query generator 123 may be pre-trained on vast corpora of text to understand and generate natural language. For example, the search query generator 123 may be trained on a corpus of historical user-generated search queries. The search query generator 123 may comprise another model for text generation which evaluates historic user-generator search queries and generates search queries based on the evaluation. The search query generator 123 may generate one or more search queries directed to content items (e.g., currently available content items, content items available in the future, or a combination thereof) using metadata associated with those content items as well as historical user-generated search queries. In some examples, the search query generator 123 may access data from the memory 119 to generate the search queries.

The search query generator 123 may cluster the search queries into one or more groups or clusters of search queries according to various similarities. The search query generator 123 may cluster historical user-generated search queries into clusters of one or more historical user-generated search queries according to similarities of structure, syntax, verbiage, or the like and use metadata associated with the historical user-generated search queries in a particular to determine a popularity, usage rate, and/or frequency of occurrence or use associated with the particular cluster. “Popular” and “popularity” are used throughout to describe a measure of use such as an actual or predicted usage rate, a frequency of occurrence or use, or the like. The search query generator 123 may map the search queries to the clusters of historical user-generated search queries based on similarities among the queries. For example, the search query generator 123 may compare a search query to a plurality of historical user-generated search queries within a particular cluster to determine similarities. If the similarities meet or exceed certain criteria (e.g., a similarity threshold, or other criterion, etc.), the search query may be added or mapped to the particular cluster. Based on the mapping of the search queries to the clusters of historical user-generated search queries, the search query generator 123 may predict a popularity, usage rate, and/or frequency of occurrence or use for the search queries. The search query generator 123 may rank the search queries based on the predicted popularity metric, usage rate metric, and/or frequency of occurrence or use metric for the particular search query, and provide a set amount of top-ranked search queries to the simulation engine 126.

The system 100 may comprise a simulation engine 126. The simulation engine 126 may comprise one or more applications, programs, services, or the like, which produce a computer environment. The simulation engine 126 may be configured to replicate user interactions with a content platform, such as the content item search interface of the content platform, in a controlled virtual setting. The simulation engine 126 may comprise a user interface emulator that may receive one or more search queries from the search query generator 123. The simulation engine 126 may be configured to simulate a content item search interface for a platform of a particular content provider 106 by conducting a test search for one or more targeted content items on the content item search interface for the platform using a search query. The simulation engine 126, based on receiving the search query may produce one or more search results (e.g., a plurality of search results), which correspond to the search results of content items resulting from the search. For example, the search results may comprise a screen capture of a search results landing page for the platform, which shows at least a portion of the content items identified during the search and in response to the search query, and which the user would see if the content item search were conducted at the content item search interface for that particular content platform. For example, the search results may comprise a ranked listing of at least a portion of the content items identified during the search and in response to the search query. For example, the search results may comprise the highest ranked or determined best matching content items identified during the search. For example, the search results may comprise a listing of the portion of the content items identified during the search that would be displayed on the first page of the content item search interface for the particular content platform.

The system 100 may comprise a discoverability engine 129. The discoverability engine 129 may comprise one or more applications, programs, services, or the like, which are configured to determine and modify the discoverability of a content item on a content item search interface of a content platform. The discoverability engine 129 may interact with one or more other components in the computing device 109 in order to determine the discoverability of a content item using a search query on a content item search interface of a content platform. For example, the discoverability engine 129 may receive the simulation search results for a particular search query from the simulation engine 126 and conduct an analysis on the simulation search results. The discoverability engine 129 may use the simulation search results to determine whether a particular search query results in the content item search interface identifying the intended content item, and if so, whether the intended content item was listed on the first page of search results, was within the top 10, 5, or 3 search results, and/or was the top search result. In some examples, the discoverability engine 129 may generate a discoverability metric for a particular search query identifying a target content item based at least in part on the simulation search results. For example, the discoverability metric may be a number, score, value or indicator of how successful the particular search query was at identifying the target content item and having the target content item indicated on the first page of content item search results, within the top 10, 5, or 3 search results on the first page, and/or identifying the target content item as the top search result on the first page of the content item search results. In some examples, the discoverability metric is a function of the predicted popularity, usage rate, and/or frequency of occurrence or use for the particular search query used to generate the simulation search results. The discoverability engine 129 may compare the discoverability metric to a threshold to determine whether a remedial action may be necessary. For example, the discoverability engine 129 may compare the discoverability metric to a threshold and determine that the discoverability metric falls below the threshold. The discoverability engine 129 may generate a recommended remedial action based on the comparison of the discoverability metric to the threshold. The discoverability engine 129 may generate a recommended remedial action if it is determined that the search query did not produce adequate results related to the target content item in the simulation. For example, adequate results may comprise one or more of the target content item being indicated on the first page of content item search results, within the top 10, 5, or 3 search results on the first page of the content item search results, and/or identifying the target content item as the top search result on the first page of the content item search results. For example, the discoverability engine 129 may conduct a remedial action.

The system 100 may be configured to predict popular search queries for content items, such as currently available content items and content items available in the future. The content providers 106, the content server 113, and the search query generator 123 may interact to utilize metadata associated with content items for generating search queries. In some examples, the content providers 106 may send metadata associated with one or more content items to the content server 113. The metadata may comprise various data about the content items (e.g., title, theme, genre, date or year first aired or released, artist/actors, etc.). Additionally, the content providers 106 may send historical search data to the content server 113. The historical search data may comprise various data about past searches conducted in the content providers' respective platforms (e.g., historical user-generated search queries, popularity or usage rate of historical user-generated search queries, content items selected based on a particular historical user-generated search query, metadata corresponding to the selected content items, etc.). The content server 113 may cause the metadata and/or the historical search data to be stored in the memory 119. In some examples, the content server 113 may send the metadata and/or historical search data to the search query generator 123.

The search query generator 123 may generate one or more search queries for a target content item based on the metadata and/or the historical search data. For example, the search query generator 123 may generate the search queries using similar syntax, structure, or verbiage as historical user-generated search queries. The search query generator 123 may generate the search queries using the metadata associated with the content items by determining corresponding metadata of previously available content items that was used to identify, rank, and/or organize one or more search results in response to historical user-generated search queries. For example, if a historical user-generated search query was “play X” and “X” was the title of the content item in the metadata associated with the content item, the search query generator 123 may generate a search query of “play Y” for a second content item where the metadata for that second content item indicates the title is “Y.” For example, if a historical user-generated search query was “play the recent X movie” and “X” was the name of one of the lead actors for the content item and included in the metadata associated with the content item, the search query generator 123 may generate a search query of “play the recent Y movie” for a second content item where the metadata for that second content item indicates one of the lead actors is “Y.”

The system 100 may be configured to determine and enhance discoverability of content items using various methods. For example, the simulation engine 126 and the discoverability engine 129 may use search queries generated by the search query generator 123 to predict whether users will be able to find one or more content items on a content item search interface of a content platform. The simulation engine 126 may receive one or more search queries from the search query generator 123. The simulation engine 126 may perform a user search of a content item search interface using the one or more search queries from the search query generator 123. Based on the results of the search, the discoverability engine 129 may determine whether or not the target content item was discovered using the search query. For example, the discoverability engine 129 may analyze the simulation search results from the simulation engine 126 to determine whether the target content items would be readily discoverable by a user. For example, a target content item may be readily discoverable if the target content item is indicated on the first page of content item search results, within the top 10, 5, or 3 search results on the first page, and/or if the target content item is listed as the top search result on the first page of the content item search results.

The discoverability engine 129 may further determine whether a remedial action is needed to enhance the discoverability of the target content item. For example, the discoverability engine 129 may compare the discoverability metric to a threshold to determine whether a remedial action is needed. If the discoverability metric falls below a threshold, or otherwise meets various criteria, the discoverability engine 129 may generate a remedial action recommendation (e.g., a discoverability recommendation) or cause a remedial action to be taken. For example, the discoverability engine 129 may determine based on the search results of the simulation that the metadata associated with the target content item requires modification for the content platform to successfully yield the target content item. For example, the metadata for the target content item may be modified to add one or more terms from the search query, thereby increasing the likelihood it would be identified and given a higher ranking in a subsequent search using the search query. For example, the metadata for the target content item may be modified to add synonyms and variables of the one or more terms from the search query. For example, portions of the metadata for the target content item may be changed (e.g., genre changed from drama to comedy, listed actors may be changed to remove an actor no longer as famous and replace them with an actor who has recently gained greater fame, etc.).

In some examples, the discoverability engine 129 may determine based on the results of the simulation that the target content item requires a “boost” or artificial inflation of the target content item within search results. For example, the discoverability engine 129 may determine that the search results of the search include the target content item, but not on the first page, or in the top 10, 5, or 3 results, etc. The discoverability engine 129 may compare the key words and/or phrases of the search query to the metadata of or associated with the target content item and determine that all key words and/or phrases used in the search query are present in the metadata. Accordingly, the discoverability engine 129 may modify the metadata of the target content item to comprise a flag or indicator to cause the target content item to appear as a top result (e.g., on the first page, as the top result, or within a specified number of the top result) when the search query is received by the content platform. The discoverability engine 129 may generate an associative list, pairing target content items to corresponding search queries and cause the content platform to reference the associative list when a search query is received. The discoverability engine 129 may use other means to sponsor, recommend, or otherwise cause the target content item to appear in the top results for particular search queries.

For purposes of illustration, application programs and other executable program components such as the search query generator 123 are shown herein as discrete blocks, although it is recognized that such programs and components may reside at various times in different storage components of the computing device 109. An implementation of the system/environment 100 may be stored on or transmitted across some form of computer readable media.

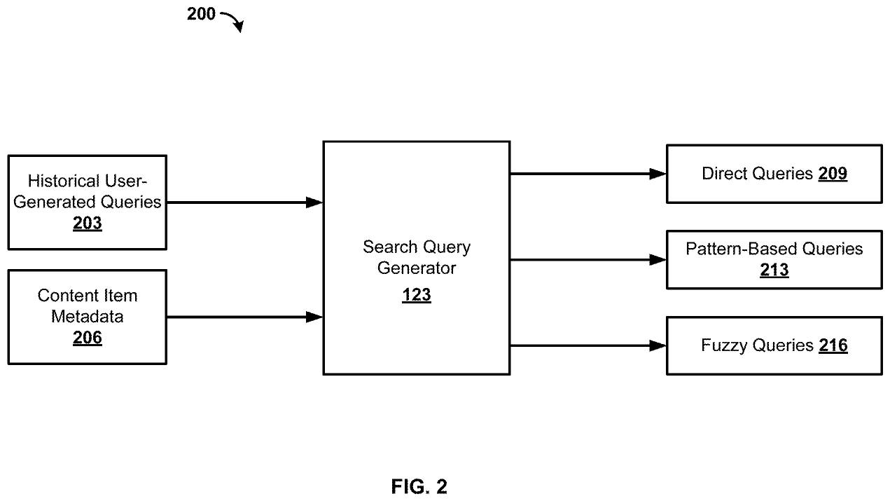

Turning now to FIG. 2, an example search query generating system 200 is depicted. The search query generating system 200 comprises the search query generator 123 receiving multiple inputs and producing multiple outputs. For example, the search query generator 123 may receive historical user-generated search queries 203. For example, the historical user-generated search queries 203 may be received from the memory 119, the content providers 106, or another system via the network 103 or another network. The historical user-generated search queries 203 are representative of historical search queries that have been provided or input by users to one or more content item search interfaces in the past to search for content items. The historical user-generated search queries 203 may have been used to search for previously available or currently available content items for viewing on the content platform.

The search query generator 123 may also receive content item metadata 206 for one or more (e.g., a plurality of) content items. For example, the content item metadata 206 may be received by the search query generator 123 from the memory 119, the content providers 106, or another system via the network 103 or another network. The content items that are being evaluated for discoverability may have associated content item metadata 206. The associated content item metadata 206 may be included with the respective content item or received separately from the content item. The content item metadata 206 may comprise various information about the features of the content item, such as the title of the content item, names of associated persons (e.g., actors, teams, anchorperson, host, commentators, etc.) in the content item, characteristics (e.g., location historical time frame, length, date first aired or released, or the like), theme(s) presented in the content item, genre(s) of the content item, or the like. Using the content item metadata 206, the search query generator 123 may determine one or more key words or phrases associated with a content item. For example, the search query generator 123 may evaluate the content item metadata for a particular content item and parse from the metadata the one or more key words and/or phrases for the content item. Similarly, using the historical user-generated search queries 203, the search query generator 123 may determine one or more query structures that are commonly used to search for content items. For example, the search query generator 123 may analyze the historical user-generated search queries 203 to determine commonalities in search query structure, syntax, verbiage, or the like among the historical user-generated search queries 203. For example, the search query generator 123 may determine that multiple historical user-generated search queries 203 use the structure of “verb-key word-platform” (e.g., “Play X on A Channel,” where “X” is found in the content item metadata 206 of the content item eventually selected for the historical user-generated search query, “Find Y on B Channel,” where “Y” is found in the content item metadata 206 of the content item eventually selected for the historical user-generated search query, etc.). The search query generator 123 may generate one or more search queries having key words and/or phrases determined from the content item metadata 206 of the target content item and in a structure or format determined from the historical user-generated search queries 203. For example, the search query generator 123 may generate a search query “Play A on Z Channel” where “A” is found in the content item metadata 206 of the target content item.

The search query generator 123 may produce a variety of forms of search queries. As shown in the example of FIG. 2, the search query generator 123 may generate direct search queries 209, pattern-based search queries 213, or fuzzy search queries 216. The search queries may be clustered into groups based on their syntax, structure, key words, or other similarities. For example, a group of direct search queries 209 may comprise short search queries directed to key words and/or phrases in the metadata of a content item (e.g., “Play X,” etc.). Pattern-based search queries 213 may have similar structures (e.g., “Play X on A Channel” and “Play Y on B Channel,” etc.). Fuzzy search queries 216 may lack definitive terminology for identifying a content item (e.g., “Play latest episode of Z show,” etc.).

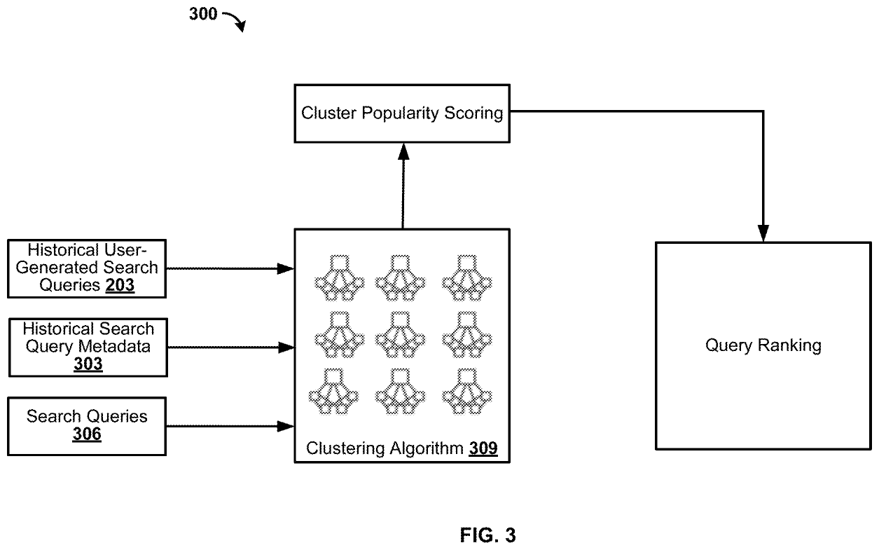

FIG. 3 shows an example search query ranking 300. The search query ranking 300 may begin by receiving or inputting various data to a clustering algorithm 309. The data may comprise the historical user-generated search queries 203 described above as well as historical search query metadata 303 and search queries 306. The historical search query metadata 303 may comprise various information about the historical user-generated search queries 203. For example, the historical search query metadata 303 may comprise associated popularity scores or metrics, usage rates, or a frequency of occurrence or use for each historical user-generated search query 203. For example, historical search query metadata 303 may have a high frequency of occurrence or use, and therefore a high popularity metric or score, as a reflection of having been used a large number of times in historical user-generated search queries by a plurality of users. For example, the popularity, usage rate, and/or frequency of occurrence or use of a historical user-generated search query 203 may be reflected in the historical search query metadata 303 as a score, a percentage, a metric, a count, a value, or the like. The search queries 306 may comprise the direct search queries 209, the pattern-based search queries 213, and fuzzy search queries 216 described above. The search queries 306 may comprise any search queries generated by the search query generator 123.

The various inputs, such as the historical user-generated search queries 203, historical search query metadata 303, and search queries 306 may be used by the clustering algorithm 309. The clustering algorithm 309 may be configured to create clusters or groups of similar search queries. For example, the clustering algorithm 309 may be a K-means clustering algorithm, a density-based clustering algorithm, a Gaussian mixture model, a Balance Iterative Reducing and Clustering using Hierarchies (BIRCH) algorithm, or any other applicable form of clustering algorithm. In some examples, the clustering algorithm 309 clusters, organizes, and/or separates the historical user-generated search queries 203 into similar groups based on structure, syntax, verbiage, and the like. Using the historical search query metadata 303, the clustering algorithm 309 may determine a popularity metric, usage rate metric, and/or frequency of occurrence or use metric for each cluster. For example, the clustering algorithm 309 may take an average of popularity metrics, usage rates, and/or frequencies of occurrence for each of the historical user-generated search queries 203 in a particular cluster to determine the popularity metric, usage rate, and/or frequency of occurrence or use for the particular cluster. For example, the clustering algorithm 309 may determine the highest average of a historical user-generated search query 203 within a cluster as the popularity metric, usage rate, and/or frequency of occurrence or use for the particular cluster.

The clustering algorithm 309 may map the search queries 306 to clusters of historical user-generated search queries 203 based on similarities in structure, syntax, verbiage, and the like. For example, the clustering algorithm 309 may compare the structure, syntax, verbiage, and the like of a search query 306 to the structures, syntaxes, verbiages, and the like of a cluster of historical user-generated search queries 203. The clustering algorithm 309 may determine a likeness measure or similarity between the search query 306 and the historical user-generated search queries 203 in the cluster. The clustering algorithm 309 may determine a predicted popularity metric, predicted usage rate, and/or predicted frequency of occurrence or use for each search query 306 based at least in part on the popularity metric, predicted usage rate, and/or frequency of occurrence or use determined for the cluster of historical user-generated search queries 203 to which the search query 306 was mapped. For example, the determination of the popularity metric, the predicted usage, and/or the frequency of occurrence or use is completed by the clustering algorithm 309. For example, the determination of the popularity metric, usage rate, and/or frequency of occurrence or use occurs as a separate process from the clustering algorithm 309. In some examples, the clustering algorithm 309 may calculate a popularity or usage metric (R(Q)) with the following equation:

R(Q)=α×Pop(Q)+β×cos(v(Q),v(c))

where Pop(Q) is the likelihood of the normalized frequency of occurrence or use of the search query in cluster c, and v(*) are embedded vectors of the search queries.

The example query ranking 300 of FIG. 3 may further comprise query ranking. The search queries 306 may be ranked by a scorer, or an application, system, or service such as the clustering algorithm 309, the query search generator 123, the discoverability engine 129, or the like. The scorer may rank the search queries 306 based on the human-likeness and relevance to a user. For example, in order to rank the search queries 306, the scorer may leverage heuristics and/or machine learning for evaluation of the search queries 306. For example, the search queries 306 may be compared to the historical user-generated search queries 203 to determine similarities in structure, syntax, verbiage, etc. Those search queries 306 which are most similar, or share the greatest number of similarities, to the historical user-generated queries 203 may receive higher rankings than those search queries 306 which are less similar. A rank for each search query 306 may be determined based at least in part by determining what group of historical user-generated search queries the search query 306 has been mapped to. For example, the ranking of the search queries 306 may be determined based at least in part on the predicted popularity metric, usage rate, and/or frequency of occurrence or use of the search query 306.

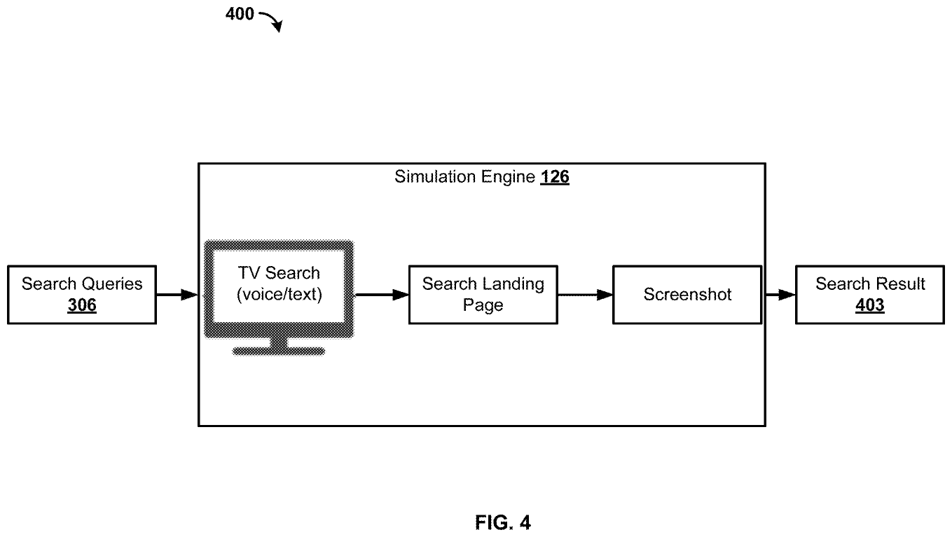

FIG. 4 shows an exemplary content item search simulation 400 for one or more content items. The content item search simulation 400 may be completed by the simulation engine 126 of FIG. 1. As shown in FIG. 4, the simulation engine 126 may receive search queries 306 as input. For example, the simulation engine 126 may receive the search queries 306 from the search query generator 123, the memory 119, the search query ranking module of FIG. 3, or another portion of the system 100. The search queries 306 may be input or received by the simulation engine 126 one or more at a time to perform independent content item search simulations. For example, a search query 306 may be input into or received by the simulation engine 126, the search simulation performed, and a simulation search result 403 obtained before the next search query 306 is input or received by the simulation engine 126.

The simulation engine 126 may begin with a content item search. For example, the content item search may be a platform-specific search for a specific content provider 106, whereby the search queries 306 may be tested. For example, the content item search may be specific to the content items (e.g., target content items) provided by the content provider 106. The content item search may make use of a search engine, or a search engine, of the intended content platform. The search engine, via a content item search interface, may be configured to receive the search queries 306 and present the most relevant content items as search results based on the search query 306. When a search query 306 is entered into an input field of the content item search interface, the simulation engine 126 may mimic the search engine of the particular content platform to produce the most relevant content items as search results. The content items identified as search results will be output or caused to be output for visual consumption on a search landing page. For example, a first portion of the content items identified as search results will be output or caused to be output for visual consumption of a first search landing page and one or more additional portions of the content items identified as search results will be output or caused to be output for visual consumption on one or more subsequent search landing pages. For example, the first portion of the content items on the first landing page may represent the highest ranking, most relevant content items with regard to the particular search query used for the search.

For example, each search landing page may comprise a display of a user interface. For example, each search landing page may comprise a graphical user interface displaying one or more content items that were determined to be most relevant to the search query 306. For example, when the content platform being searched is a for a cable television provider, the search landing page may comprise a graphical user interface configured to display the most relevant content items (e.g., TV shows, movies, sporting events, news shows, talk shows, channels, or other content items) which correspond to the search query 306. For example, the search landing page may comprise a listing of search results, or content items returned by the simulation engine 126 in response to the input or received search query 306.

For example, the simulation engine 126 may capture a screenshot or a screen capture of the search landing page. The simulation engine 126 may use the screen capture to analyze the results displayed in the search landing page as the user would see them. For example, the screenshot may comprise only the top and most visible search results that a user would initially see when the search landing page is output. For example, the screenshot may only include the content items listed on the first search landing page, and may not include those additional search results that were identified based on the search query but did not appear on the first page of the search landing page. The simulation engine 126 may use computer vision techniques (optical character recognition (OCR), object detection, image classification, etc.) to analyze the search results and determine where the target content item appears in the search results.

After completing the content item search simulation, the simulation engine 126 may produce one or more search results 403. The search results 403 may comprise a screenshot of the search landing page (e.g., the first search landing page) for each search query 306 that was provided to the simulation engine 126. In some examples, the search results 403 may comprise a list of the top search results (e.g., content item titles) for each search query 306. For example, the top search results may comprise only the top or first content item in the listing of the search results, the top 3 content items, the top 5 content items, the top 10 content items, etc. The search results 403 may comprise a list of one or more content items identified during the search identified in response to a search query 306.

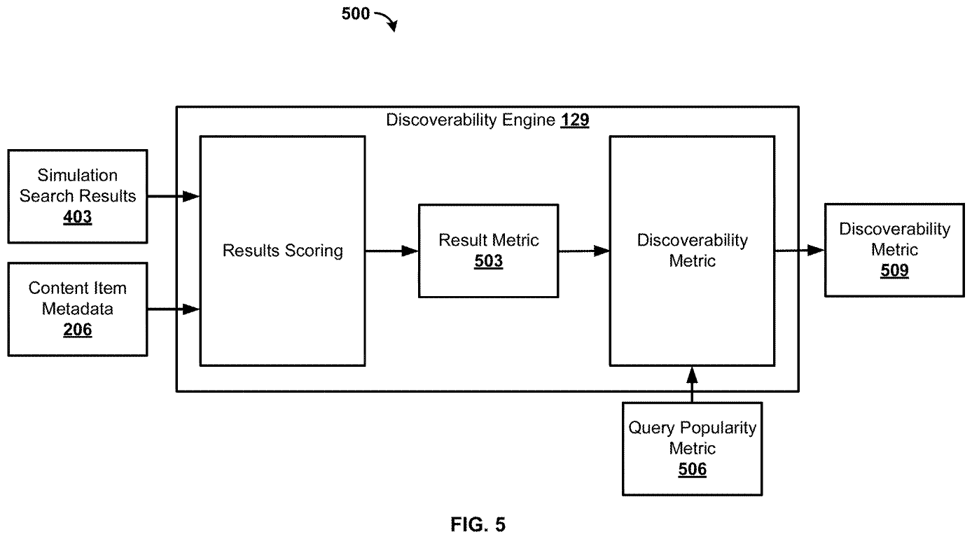

FIG. 5 shows an example method 500 for determining the discoverability of a target content item. To determine the discoverability of a target content item, the discoverability engine 129 may receive various data inputs, and based on those inputs, generate an output indicating the discoverability of the target content item. For example, the various inputs provided to the discoverability engine 129 may comprise search results 403 along with the search query 306 corresponding to the search results 403. For example, the search results 403 and the search query may be received from the memory 119, the search query generator 123, the simulation engine 129, or other element of the system 100 via the network 103 or another network. For example, search results 403 may be sent to or received by the discoverability engine 129 for a variety of search queries 306 that were tested in the simulation engine 126. Additionally, content item metadata 206 may be sent to and/or received by the discoverability engine 129. The content item metadata 206 may correspond to the particular target content items for which the search queries 306 were generated.

These inputs may be used by the discoverability engine 129 to perform scoring of the search results 403. For example, the discoverability engine 129 may analyze the search results 403 in view of the content item metadata 206. For example, when the search results 403 comprise screenshots or OCR data of the content items identified during the search on the search landing page, the discoverability engine 129 may conduct a results validation to determine how effective the search query 306 was at identifying the associated target content item such that the target content item was indicated on the first page of the search landing page, was in the top 10 of search results, top 5 of search results, top 3 of search results, or the top search result for the search query 306. The results validation may utilize one or more forms of artificial intelligence and/or computer vision techniques to interpret the results and analyze the interpretation. For example, the results validation may comprise using computer vision techniques, such as optical character recognition (OCR), to extract text from the image. The text may be analyzed using an LLM or other text interpretation tool. Using these tools, the discoverability engine 129 may determine whether the screenshot includes the targeted content item for the associated search query 306. For example, the discoverability engine 129 may compare text in the search results 403 to the content item metadata 206 to determine whether the search results 403 include the target content items.

The discoverability engine 129 may produce a result metric 503 that indicates how well the search query 306 identified the target content item as one of the top or higher ranking search results. For example, the result metric 503 may be a score or indication of how well the search query 306 did identifying the target content item as one of the top or higher ranking search results. For example, the result metric 503 may be determined based at least in part on the analysis of the search results 403. In some examples, the result metric 503 may represent a numerical value, a letter grade, a categorical result, an indicator, or the like. The discoverability engine 129 may categorize the search results 403 as positive (e.g., when the search results 403 include the target content item as one of the top k results, where k is a whole number integer such as 1, 3, 5, 10, etc.), indefinite (e.g., when the search results 403 include the target content item lower in the results), or negative (e.g., when the search results 403 do not include the target content item). For example, the discoverability engine 129 may determine a numerical score for the search results 403 (e.g., a score of “1” for search results 403 where the target content item is in the top k results; a score of “0.5” for search results 403 where the target content item is present but not within the top k results; a score of “0” for search results 403 where the target content item is not present in the content items identified during the search). The discoverability engine 129 may produce a variety of types of result metrics 503 for the search results 403 depending upon where, if anywhere, the target content item appears within the search results 403.

The discoverability engine 129 may use the result metric 503 to determine discoverability. As shown in the example of FIG. 5, the discoverability engine 129 may use the result metric 503 in combination with the query usage metric 506 of the search query corresponding to the search results 403. The query usage metric 506, which may be determined in the search query ranking 300 of FIG. 3, may represent the predicted popularity, usage rate, and/or frequency of occurrence or use of the search query 306 based on the popularity, usage rate, and/or frequency of occurrence or use of similar historical user-generated search queries 203. The discoverability engine 129 may use the result metric 503 and the query usage metric 506 to generate a discoverability metric 509. For example, the discoverability engine 129 may use a weighted calculation to generate the discoverability metric 509, weighing the query usage metric 506 greater than the result metric 503. In this manner, the likelihood that a search query 306 will be asked is valued more than the result metric 503 in order to prioritize remedial actions for the most popular search queries (e.g., predicted highest usage rate and/or predicted highest frequency of occurrence or use). For example, the result metric 503 and the query usage metric 506 may be added or summed in a weighted combination to generate the discoverability metric 509 for a search query 306. For example, the result metric 503 and the query usage metric 506 for each search query 306 associated with a particular target content item may be combined in a weighted average to generate an average discoverability metric 509 for all the search queries 306 directed toward the particular target content item. Various other methods of calculating discoverability metrics 509 are also possible. For example, the discoverability metric 509 may be calculated using the following equation:

$$Discoverability ( E ) = \frac{1}{N} \times {\sum }_{i = 1}^{N} \frac{( {R ( {Q}_{i} )}^{a} \times {U ( {Q}_{i} )}^{β}}{1 + k \times {( 1 - U ( {Q}_{i} ) )}^{η}}$$

where Qᵢ represents the search queries {Q₁, Q₂, . . . Qₙ} generated for the target content item E. Exponent α may fall within the range of about 0 to 5, or 1 to 3; exponent β may fall within the range of about 0 to 3, or 1 to 2; and where k is in the range of about 0 to 1.

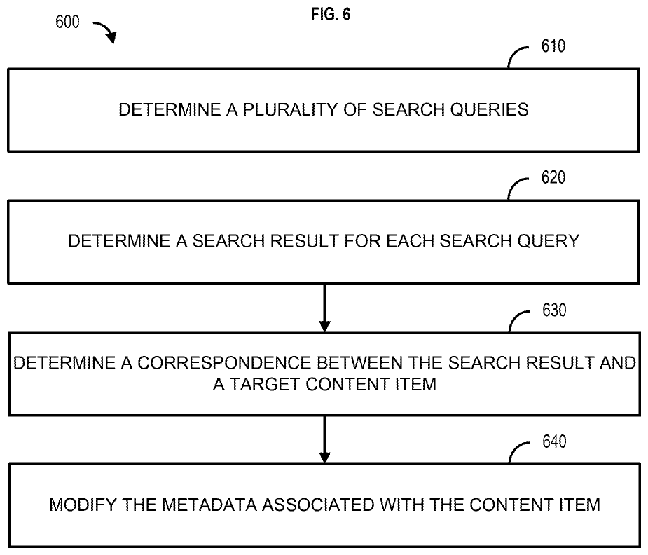

FIG. 6 shows a flowchart of an example method 600. The method 600 may be performed in whole or in part by a single computing device, a plurality of computing devices, and the like. For example, the method 600 may be performed by the computing device 109, a computing device in communication with the computing device 109 or any other computing device described herein. For example, a portion of the method 600 may be performed by a first computing device, while another portion of the method 600 may be performed by another computing device. For ease of explanation, the method 600 will be described as being performed by the computing device 109.

At 610, the computing device 109 may determine a plurality of search queries, such as search queries 306. For example, the computing device 109 may generate the plurality of search queries 306. For example, a search query generator 123 may determine and/or generate one or more search queries 306 directed to trying to identify a target content item from a plurality of content items using a search database for a particular content platform of a content provider 106. The search query generator 123 may generate the search queries 306 based on metadata associated with one or more content items or the target content item (e.g., content item metadata 206). For example, the search query generator 123 may generate search queries 306 that comprise key words, or synonyms of key words, from the content item metadata 206. In some examples, the search query generator 123 generates the search queries 306 based on historic query data, or historical user-generated search queries 203. For example, the search query generator 123 may be trained on historical user-generated search queries 203 to generate search queries 306 in the form or style of the historical user-generated search queries 203.

The computing device 109 may rank the plurality of search queries 306. As described in the example of FIG. 3, the computing device 109 may comprise a clustering algorithm 309 for predicting a popularity of each search query 306. The clustering algorithm 309 and ranking process may rank the plurality of search queries 306 according to a predicted popularity by clustering a plurality of historic queries, or historical user-generated search queries 203. The clustering algorithm 309 may cluster the historical user-generated search queries 203 based on one or more structural similarities among the historical user-generated search queries 203. The clustering algorithm 309 may produce one or more clusters of historical user-generated search queries 203 to map or assign each search query of the plurality of search queries 306 to a cluster of the one or more clusters. For example, the clustering algorithm 309 may cluster the historical user-generated search queries 203 into one or more clusters based on structural similarities and then map a search query 306 to a cluster because the structure of the search query 306 is aligned with that of the historical user-generated search queries 203 in the cluster. The clustering algorithm 309 is further able to metric each cluster of the one or more clusters based on popularity data for the plurality of historic queries. For example, the historical user-generated search queries 203 of each cluster may be associated with various popularity data or historical search query metadata 303 which indicates the number of times a particular historical user-generated search query 203 was searched. The historical search query metadata 303 may be interpreted to assign a usage metric to the historical user-generated search query 203 and to determine an average usage metric for the cluster of historical user-generated search queries 203. The search queries 306 may be mapped to the one or more clusters by comparing the plurality of search queries 306 to the plurality of historical user-generated search queries 203 within each cluster and grouping the search queries 306 in respective clusters according to structural similarities.

Based on mapping the search queries 306 to the one or more clusters, the clustering algorithm 309 may determine a metric or rank for each search query of the plurality of search queries 306. For example, the clustering algorithm 309 may score a search query 306 with the usage metric for the cluster to which the search query 306 is assigned. The computing device 109 may be configured to predict a popularity of each search query of the plurality of search queries by ranking the search queries 306 according to the respective predicted usage metric of the cluster. In some examples, the search queries 306 are ranked from the highest predicted popularity to the lowest predicted popularity.

At 620, the computing device 109 may determine a search result to each search query 306. For example, the computing device 109 may simulate a user search experience for each search query 306. The computing device 109 may comprise a simulation engine 126 to conduct a search. The simulation engine 126 may produce a user environment (e.g., a synthetic user environment) that comprises the target content item(s) as well as other, non-target content items (e.g., a plurality of non-target content items). The simulation engine 126 may test each search query 306 to produce a search result. For example, the simulation engine 126 may query the user environment using a search query 306. The simulation engine 126 may produce an output or a search result 403 of the user environment. In some examples, the output or search result 403 comprises one or more content items identified during the search. The search result 403 may comprise an image of a user interface having the one or more content items identified during the search.

At 630, the computing device 109 may determine a correspondence between the search result and the target content item. For example, a correspondence between the search result and the target content item may be determined by identifying the target content item in the search result 403. The computing device 109 may comprise a discoverability engine 129 capable of determining, for each search query of the plurality of search queries 306, a correspondence between the search result 403 and the target content items. The discoverability engine 129 may be configured to analyze the search results 403 by comparing the one or more content items identified during the search in the search result 403 to the target content item. The discoverability engine 129 may determine that there is a correspondence between the content items identified during the search and the target content item, or determine that there is not a correspondence between the content items identified during the search and the target content item. For example, the discoverability engine 129 may determine that the target content item is identified as one of the content items identified during the search, or that the target content item is not identified as one of the content items identified during the search. For example, the discoverability engine 129 may determine a degree of correspondence by determining a position of the target content item within the content items identified during the search and where that position is relative to the top of the search results. The discoverability engine 129 may use the determination of the position of the content item to determine whether a modification is necessary.

At 640, the computing device 109 may modify the metadata associated with the target content item. In some examples, the discoverability engine 129 may cause a remedial action to be taken based on the determined correspondence and the usage metric 506 of a respective search query 306. For example, if the discoverability engine 129 determines that there is not a correspondence between the content items identified during the search and the target content item at 640, the discoverability engine 129 may reference the usage metric 506 of the search query 306. In some examples, the discoverability engine 129 may compare the usage metric 506 of the search query 306 to a threshold to determine whether a remedial action is necessary. For example, if the discoverability engine 129 determines that the search query 306 meets or exceeds the threshold, a remedial action may be taken.

The discoverability engine 129 may determine that the usage metric 506, usage rate, and/or frequency of use of the search query 306 is low or falls below a threshold, and determine that no remedial action is necessary. However, if the discoverability engine 129 determines that the usage metric 506 of the search query 306 is high and the correspondence between the content items identified during the search and the target content item is low or does not correspond, the discoverability engine 129 may determine that a remedial action is necessary. Once it is determined that a remedial action is necessary, the discoverability engine 129 may compare the search query 306 to the metadata associated with the target content item. In some examples, the discoverability engine 129 may determine that the key words used in the search query 306 are absent from the metadata. In such case, the discoverability engine 129 may modify the metadata associated with the target content item to comprise the key words of the search query 306. In some examples, the metadata associated with the target content item may be modified to comprise a marker, indicator, or other means inflate the likelihood of the target content item appearing as one of the content items identified during the search when the search query 306 is searched. Other examples are possible as well.

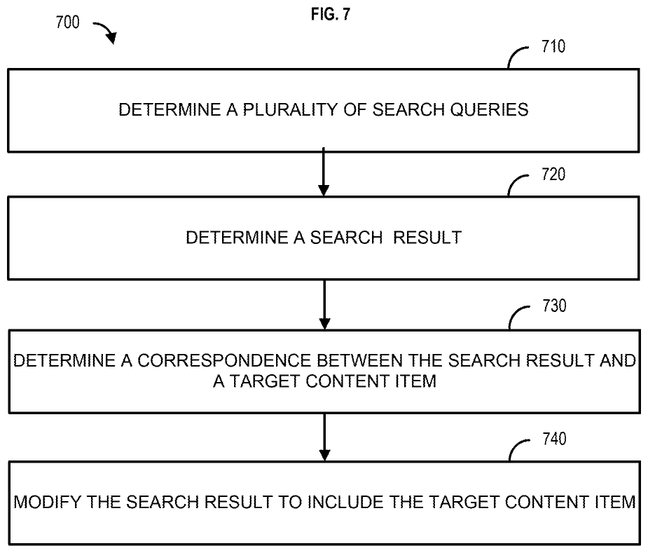

FIG. 7 shows a flowchart of an example method 700. The method 700 may be performed in whole or in part by a single computing device, a plurality of computing devices, and the like. For example, the method 700 may be performed by the computing device 109, a computing device in communication with the computing device 109 or any other computing device described herein. For example, a portion of the method 700 may be performed by a first computing device, while another portion of the method 700 may be performed by another computing device. For ease of explanation, the method 700 will be described as being performed by the computing device 109.

At 710, the computing device 109 may determine a plurality of search queries. For example, the search queries may be the search queries 306. For example, the computing device 109 may generate a plurality of search queries 306. As described above, a search query generator 123 may generate one or more search queries 306 directed to a target content item. The search query generator 123 may generate the search queries 306 based on metadata associated with one or more content items or the target content item (e.g., content item metadata 206). For example, the search query generator 123 may generate search queries 306 that comprise key words and/or phrases, or synonyms of key words and/or phrases, from the content item metadata 206. In some examples, the search query generator 123 generates the search queries 306 based on historical search query data, or historical user-generated search queries 203. For example, the search query generator 123 may be trained on historical user-generated search queries 203 to generate search queries 306 in the form or style of the historical user-generated search queries 203 as described above.

The computing device 109 may rank the plurality of search queries 306. As described above, the search queries 306 may be ranked according to a usage metric 506 of the search query 306. The computing device 109 may comprise a clustering algorithm 309 for predicting a popularity, usage rate, and/or frequency of occurrence or use of each search query 306. The clustering algorithm 309 and ranking process may rank the plurality of search queries 306 according to a usage metric 506 by clustering a plurality of historic queries, or historical user-generated search queries 203. The clustering algorithm 309 may cluster the historical user-generated search queries 203 based on one or more structural similarities among the historical user-generated search queries 203. The clustering algorithm 309 may produce one or more clusters of historical user-generated search queries 203 to map or assign each search query of the plurality of search queries 306 to a cluster of the one or more clusters. For example, the clustering algorithm 309 may cluster the historical user-generated search queries 203 into one or more clusters based on structural similarities and then map a search query 306 to a cluster because the structure of the search query 306 shares one or more similarities with the structure of the historical user-generated search queries 203 in the cluster. For example, the clustering algorithm 309 may cluster the historical user-generated search queries 203 into one or more clusters based on syntax, verbiage, or other features and then map a search query 306 to a particular cluster because the search query 306 shares one or more similarities with the historical user-generated search queries 203 in that particular cluster. The clustering algorithm 309 is further able to score or rank each cluster of the one or more clusters based on historical popularity, usage rate, and/or frequency of occurrence or use data for the plurality of historic queries. For example, the historical user-generated search queries 203 of each cluster may be associated with various popularity, usage rate, and/or frequency of occurrence or use data or historical search query metadata 303 which may indicate a number of times a particular historical user-generated search query 203 was searched. The historical search query metadata 303 may be interpreted to assign a usage metric 506 to the historical user-generated search query 203 and to determine an average usage metric 506 for the cluster of historical user-generated search queries 203. The search queries 306 may be mapped to the one or more clusters by comparing the plurality of search queries 306 to the plurality of historical user-generated search queries 203 within each cluster and grouping the search queries 306 in respective clusters according to structural, syntax-based, verbal, or other similarities.

Based on mapping the search queries 306 to the one or more clusters, the clustering algorithm 309 may determine a metric or rank for each search query of the plurality of search queries 306. For example, the clustering algorithm 309 may score a search query 306 with the usage metric 506 for the cluster to which the search query 306 is assigned. The computing device 109 may be configured to predict a popularity, usage rate, and/or frequency of occurrence or use of each search query of the plurality of search queries 306 by ranking the search queries 306 according to the respective usage metric 506 of the cluster. In some examples, the search queries 306 are ranked from the highest usage metric 506 to the lowest usage metric 506.

At 720, the computing device 109 may determine a search result for one or more of the search queries, such as each search query. The search result may comprise one or more content items identified during the search. For example, the computing device 109 may simulate a user search experience for each search query 306. As described above, the computing device 109 may comprise a simulation engine 126 to conduct a user search experience. The simulation engine 126 may produce a synthetic user environment that comprises the target content item(s) as well as non-target content items. The simulation engine 126 may test each search query 306 to identify a search result. For example, the simulation engine 126 may query the synthetic user environment using a search query 306. The simulation engine 126 may identify an output or a search result 403 of the synthetic user environment. For example, the output or search result 403 may comprise one or more content items identified during the search. For example, the search result 403 may comprise an image of a user interface having the one or more content items identified during the search.

At 730, the computing device 109 may determine a correspondence between the search result and the target content item. The computing device 109 may comprise a discoverability engine 129 capable of determining, for each search query of the plurality of search queries 306, a correspondence between the search result and the target content items. The discoverability engine 129 may be configured to analyze the search results 403 by comparing the one or more content items identified during the search in the search result 403 to the target content item. The discoverability engine 129 may determine that there is a correspondence between the content items identified during the search and the target content item, or determine that there is not a correspondence between the content items identified during the search and the target content item. For example, the correspondence may be determined by comparing the search result 403 and the target content item and identifying whether the target content item is present within the content items identified during the search of the search result 403. The correspondence may be a positive or negative result (e.g., the target content item is identified within the search result 403 or is not identified within the search result 403). For example, the correspondence may be a degree of correspondence, where the correspondence is higher when the target content item is identified higher in the listing of content items identified during the search, and is lower when the target content item is identified lower in the listing of content items identified during the search.

At 740, the computing device 109 may modify the search results associated with a search query. For example, the search results may be modified to comprise the target content item and/or to move the target content item higher up in the search results, such that it would be the first search result, in the top five search results, and/or would be visible on a first page or generated search results for the particular search query. For example, the computing device 109 may modify the user search experience to identify the target content item. In some examples, the discoverability engine 129 may cause a remedial action to be taken based on the determined correspondence from 740 and the usage metric 506 of a respective search query 306. For example, if the discoverability engine 129 determines that there is not a correspondence or there is a low correspondence between the content items identified during the search and the target content item at 740, the discoverability engine 129 may reference the usage metric 506 of the search query 306. In some examples, the discoverability engine 129 may compare the usage metric 506 of the search query 306 to a threshold to determine whether a remedial action is necessary. For example, if the discoverability engine 129 determines that the search query 306 meets or exceeds the threshold, it is more likely that a remedial action will be necessary.

The discoverability engine 129 may determine that the usage metric 506 of the search query 306 is low or falls below a threshold, and determine that no remedial action is necessary. However, if the discoverability engine 129 determines that the usage metric 506 of the search query 306 is high and the correspondence between the content items identified during the search and the target content item is low, the discoverability engine 129 may determine that a remedial action is necessary. Once it is determined that a remedial action is necessary, the discoverability engine 109 may compare the search query 306 to the metadata associated with the target content item. In some examples, the discoverability engine 129 may determine that key words and/or phrases used in the search query 306 are present in the metadata. In such case, the discoverability engine 129 may determine that no modification to the key words and/or phrases in the metadata associated with the target content item will improve the discoverability of the content item. The discoverability engine 129 may determine that a flag, marker, indicator, associative list, or other tool is necessary to improve discoverability of the target content item. In some examples, the metadata of the target content item may be modified using a flag, marker, indicator, or association with the particular search query 306 to inflate the likelihood of the target content item appearing as one of the content items identified during the search when the search query 306 is searched. The discoverability engine 129 may modify the search algorithm in the content platform to return the target content item when the search query 306 is searched. For example, the discoverability engine 129 may cause the target content item to be a pinned result in response to the entry of the search query 306. Other examples are possible as well.

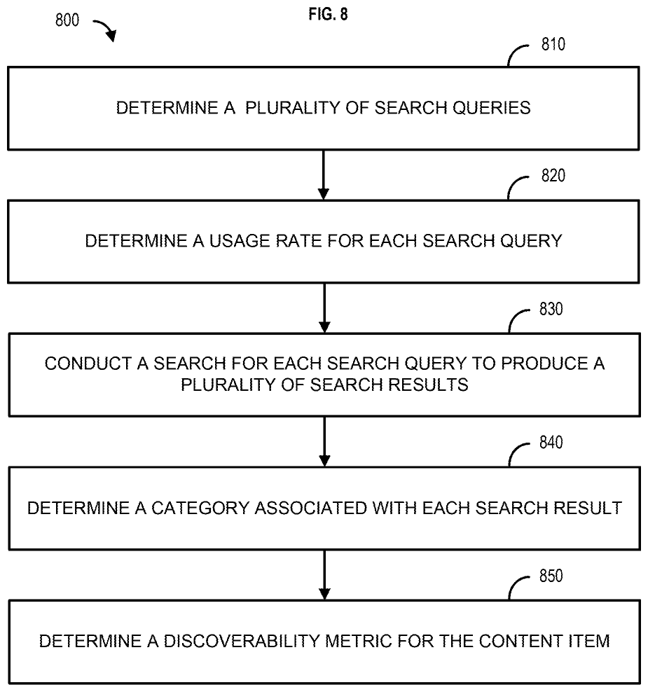

FIG. 8 shows a flowchart of an example method 800. The method 800 may be performed in whole or in part by a single computing device, a plurality of computing devices, and the like. For example, the method 800 may be performed by the computing device 109, a computing device in communication with the computing device 109, or any other computing device described herein. For example, a portion of method 800 may be performed by a first computing device, while another portion of the method 800 may be performed by another computing device. For ease of explanation, the method 800 will be described as being performed by the computing device 109.

At 810, the computing device 109 may determine a plurality of search queries. For example, the search queries may comprise the search queries 306. For example, the computing device 109 may generate the plurality of search queries 306. As described above, a search query generator 123 may generate one or more search queries 306 directed to a target content item. The search query generator 123 may generate the search queries 306 based on metadata associated with one or more content items or the target content item (e.g., content item metadata 206). For example, the search query generator 123 may generate search queries 306 that comprise key words and/or phrases, or synonyms of key words and/or phrases, from the content item metadata 206. In some examples, the search query generator 123 generates the search queries 306 based on historic query data, or historical user-generated search queries 203. For example, the search query generator 123 may be trained on historical user-generated search queries 203 to generate search queries 306 in the form or style of the historical user-generated search queries 203.

At 820, the computing device 109 may determine a usage rate for each search query of the plurality of search queries 306. For example, the computing device 109 may rank the plurality of search queries 306. As described above, the search queries 306 may be ranked according to a usage metric 506 of the search query 306. The computing device 109 may comprise a clustering algorithm 309 for predicting a popularity, usage rate, and/or frequency of occurrence or use of each search query 306. The clustering algorithm 309 and ranking process may rank the plurality of search queries 306 according to a usage metric 506 by clustering a plurality of historic queries, or historical user-generated search queries 203. The clustering algorithm 309 may cluster the historical user-generated search queries 203 based on one or more structural similarities among the historical user-generated search queries 203. The clustering algorithm 309 may produce one or more clusters of historical user-generated search queries 203 to map or assign each search query of the plurality of search queries 306 to a cluster of the one or more clusters. For example, the clustering algorithm 309 may cluster the historical user-generated search queries 203 into one or more clusters based on structural similarities and then map a search query 306 to a cluster because the structure of the search query 306 shares one or more similarities with the structure of the historical user-generated search queries 203 in the cluster. For example, the clustering algorithm 309 may cluster the historical user-generated search queries 203 into one or more clusters based on syntax, verbiage, or other features and then map a search query 306 to a particular cluster because the search query 306 shares one or more similarities with the historical user-generated search queries 203 in that particular cluster. The clustering algorithm 309 is further able to score or rank each cluster of the one or more clusters based on historical popularity, usage rate, and/or frequency of occurrence or use data for the plurality of historic queries. For example, the historical user-generated search queries 203 of each cluster may be associated with various popularity, usage rate, and/or frequency of occurrence or use data or historical search query metadata 303 which may indicate a number of times a particular historical user-generated search query 203 was searched. The historical search query metadata 303 may be interpreted to assign a usage metric 506 to the historical user-generated search query 203 and to determine an average usage metric 506 for the cluster of historical user-generated search queries 203. The search queries 306 may be mapped to the one or more clusters by comparing the plurality of search queries 306 to the plurality of historical user-generated search queries 203 within each cluster and grouping the search queries 306 in respective clusters according to structural, syntax-based, verbal, or other similarities.

Based on mapping the search queries 306 to the one or more clusters, the clustering algorithm 309 may determine a metric or rank for each search query of the plurality of search queries 306. For example, the clustering algorithm 309 may score a search query 306 with the usage metric for the cluster to which the search query 306 is assigned. The computing device 109 may be configured to predict a popularity of each search query of the plurality of search queries 306 by ranking the search queries 306 according to the respective predicted usage metric of the cluster. In some examples, the search queries 306 are ranked from the highest usage metric 506 to the lowest usage metric 506.

At 830, the computing device 109 may conduct a search using each search query to produce a plurality of search results. For example, the computing device 109 may simulate a user search experience for each search query 306. As described above, the computing device 109 may comprise a simulation engine 126 to conduct a user search experience. The simulation engine 126 may produce a synthetic user environment that comprises the target content item(s) as well as other, non-target content items. The simulation engine 126 may test each search query 306 to produce a search result. For example, the simulation engine 126 may query the synthetic user environment using a search query 306. The simulation engine 126 may produce an output or a search result 403 of the synthetic user environment. In some examples, the output or search result 403 comprises one or more content items identified during the search. The search result 403 may comprise an image of a user interface having the one or more content items identified during the search.

At 840, the computing device 109 may determine a category for each search result 403. For example, the computing device 109 may determine the category for each of the search results 403 based on a correspondence between the search results 403 and the content item. For example, a correspondence between the search result and the target content item may be determined by identifying the target content item in the search result 403. For example, the correspondence may be determined by comparing the search result 403 and the target content item and identifying whether the target content item is present within the content items identified during the search of the search result 403. The correspondence may be a positive or negative result (e.g., the target content item is identified within the search result 403 or is not identified within the search result 403). For example, the correspondence may be a degree of correspondence, where the correspondence is higher when the target content item is identified higher in the listing of content items identified during the search, and is lower when the target content item is identified lower in the listing of content items identified during the search. For example, if the search results 403 comprise content items identified during the search which correspond to the target content item, the computing device 109 may categorize the search results 403 accordingly. Categorizing the search results 403 may comprise assigning, based on the one or more content items identified during the search corresponding to the content item, a positive categorization to a search result. In some examples, the search results 403 may be assigned a negative categorization if the content items identified during the search do not correspond to the target content item. The computing device 109 may assign an indefinite categorization to a search result 403 based on the one or more content items identified during the search partially corresponding to the target content item. For example, if the content items identified during the search may comprise the target content item, but may not include the target content item near the top of the results or within a certain range of the top result, the categorization of indefinite may be assigned. In some examples, the discoverability engine 129 may produce a numerical score for the search results 403 (e.g., a score of “1” for search results 403 where the target content item is within the top k results; a score of “0.5” for search results 403 where the target content item is present but not within the top k results; a score of “0” for search results 403 where the target content item is not present in the content items identified during the search). In some examples, a remedial action may be necessary depending on the categorization of the search results 403.

At 850, the computing device 109 may determine a discoverability metric 509 for the target content item. As described in the discussion of FIG. 5, the discoverability engine 129 may use the categorization to perform discoverability scoring. The discoverability engine 129 may use the categorization in combination with the query usage metric 506 of the search query corresponding to the search results 403. The query usage metric 506, determined as described above, may represent the predicted popularity, usage rate, and/or frequency of occurrence or use of the search query 306 based on the popularity, usage rate, and/or frequency of occurrence or use of similar historical user-generated search queries 203. The discoverability engine 129 may use the categorization and the query usage metric 506 to generate a discoverability metric 509. For example, the discoverability engine 129 may use a weighted calculation to generate the discoverability metric 509, weighing the query usage metric 506 greater than the categorization. In this manner, the likelihood that a search query 306 will be asked is valued more than the categorization in order to prioritize remedial actions for the most used queries. In some examples, the categorization and the query usage metric 506 are added in a weighted combination to generate the discoverability metric 509 for a search query 306. In some examples, the categorization and the query usage metric 506 for each search query 306 are combined in a weighted average to generate an average discoverability metric 509 for all the search queries 306 directed toward a particular target content item. Various other methods of calculating discoverability metrics 509 are also possible.

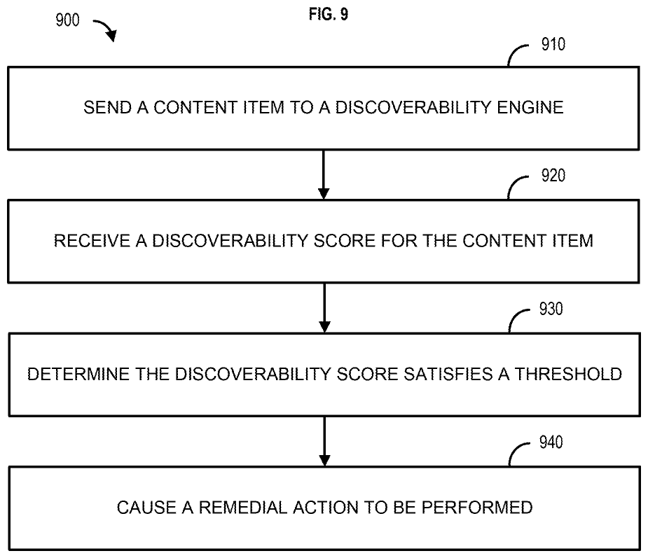

FIG. 9 shows a flowchart of an example method 900. The method 900 may be performed in whole or in part by a single computing device, a plurality of computing devices, and the like. For example, the method 900 may be performed by the computing device 109, a content provider 106, and/or a computing device in communication with the computing device 109. Some portions of the method 900 may be performed by a first computing device, while other portions of the method 900 may be performed by another computing device. For ease of explanation, the method 900 will be described as being performed by the content provider 106.

At 910, the content provider 106 may send or input a content item to a discoverability engine 129. In some examples, the content provider 106 sends or inputs one or more content items to a discoverability engine 129 to determine a discoverability metric 509 for the content items. The content provider 106 may send the content item(s) and metadata associated with the content item(s). At 920, the content provider 106 may receive a discoverability metric 509 for the content item. The discoverability metric 509 may be a function of the popularity of the content item, the popularity, usage rate, and/or frequency of occurrence or use of particular searches, and the likelihood that the content item will appear in the top results when searched in the content provider's platform. The content provider 106 may receive the discoverability metric 509 from the discoverability engine 129 in response to having sent the content item and its associated metadata. The content provider 106 may receive a discoverability metric 509 for each content item that was sent at 910.

At 930, the content provider 106 may determine that the discoverability metric 509 falls below a threshold. In some examples, the content provider 106 may have a threshold level of discoverability for each content item. For example, if the discoverability metric 509 received at 920 falls below the threshold, the content provider 106 may determine that a remedial action is necessary. For example, if the discoverability metric 509 received at 920 meets or exceeds the threshold, the content provider 106 may determine that no remedial action is necessary.

At 940, the content provider 106 may cause a remedial action to be performed. For example, the content provider 106 may cause a remedial action to be performed in response to determining that the discoverability metric 509 falls below a threshold at 930. The remedial action may be determined based at least in part on the discoverability metric 509 and/or associated metadata. In some examples, a remedial action recommendation is received along with the discoverability metric 509 at 920. The content provider 106 may determine a remedial action based at least in part on the content item and the associated metadata that was sent at 910. The remedial action may comprise a modification to the metadata of the content item, a modification of the content provider's search platform, or another remedial action. Other examples are possible as well.

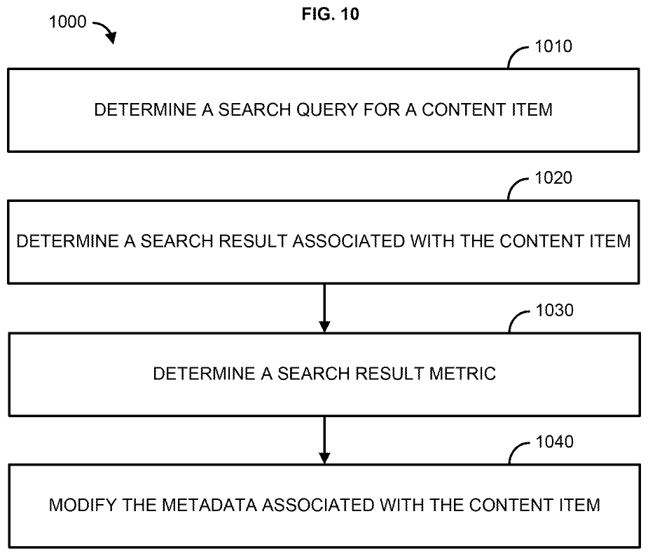

FIG. 10 shows a flowchart of an example method 1000. The method 1000 may be performed in whole or in part by a single computing device, a plurality of computing devices, and the like. For example, the method 1000 may be performed by the computing device or environment 109, a computing device in communication with the computing device or environment 109 or any other computing device described herein. For example, a portion of the method 1000 may be performed by a first computing device, while another portion of the method 1000 may be performed by another computing device. For ease of explanation, the method 1000 will be described as being performed by the computing device or environment 109.

At 1010, the computing device 109 may determine a search query for the content item, such as one of the search queries 306. For example, the content item may not be available or not yet be available to be searched by all or at least a portion of the users of a search query system of a content provider. The search query may be identified to determine how well the search query, and potentially a plurality of other search queries, is at identifying the content item in a database that comprises a plurality of other content items that may or may not be identified by the particular search query.

For example, the computing device 109 may generate the search query of the one of the search queries 306. For example, a search query generator 123 may determine and/or generate the search query 306 directed to trying to identify the content item from a plurality of other content items using a search database for a particular content platform of a content provider 106. The search query generator 123 may generate the search query based on metadata from or associated with the content item and/or one or more other of the other plurality of content items (e.g., content item metadata 206). For example, the metadata or associated with content item may include the title of the content item, one or more actor's names, the genre for the content item, a brief summary of the content item. Any one or more of these or portions of these may be included in the search query. For example, the search query generator 123 may generate the search query 306 that comprises key words, or synonyms of key words, from the content item metadata 206. For example, the search query generator 123 generates the search query based on historic query data, or historical user-generated search queries 203. For example, the search query generator 123 may use a machine-learning model to train the search query generator 123 on historical user-generated search queries 203 to generate the search query in the form or style of one or more of the historical user-generated search queries 203.

The computing device 109 may rank the search query against one or more of a plurality of other search queries 306. As described in the example of FIG. 3, the computing device 109 may comprise a clustering algorithm 309 for predicting a popularity of each search query 306. The clustering algorithm 309 and ranking process may rank the search query according to a predicted popularity by clustering a plurality of historic queries, or historical user-generated search queries 203. The clustering algorithm 309 may cluster the historical user-generated search queries 203 based on one or more structural similarities among the historical user-generated search queries 203. The clustering algorithm 309 may produce one or more clusters of historical user-generated search queries 203 to map or assign the search query and one or more other of the plurality of other search queries to a cluster of the one or more clusters. For example, the clustering algorithm 309 may cluster the historical user-generated search queries 203 into one or more clusters based on structural similarities and then map the search query and one or more other of the plurality of other search queries to a cluster because the structure of the particular search query is the same as or otherwise aligned with that of the historical user-generated search queries 203 in the cluster. The clustering algorithm 309 is further able to metric each cluster of the one or more clusters based on popularity data for the plurality of historical queries. For example, the historical user-generated search queries 203 of each cluster may be associated with various popularity data or historical search query metadata 303 which indicates the number of times a particular historical user-generated search query 203 was entered by a user for a search. The historical search query metadata 303 may be interpreted to assign a usage metric to the historical user-generated search query 203 and to determine an average usage metric for the cluster of historical user-generated search queries 203. The search query and one or more other of the plurality of other search queries 306 may be mapped to the one or more clusters by comparing the search query and one or more other of the plurality of other search queries 306 to the plurality of historical user-generated search queries 203 within each cluster and grouping the search query and one or more other of the plurality of other search queries in respective clusters according to structural similarities.

Based on mapping the search query and one or more other of the plurality of other search queries to the one or more clusters, the clustering algorithm 309 may determine a metric or rank for the search query against one or more other of the plurality of other search queries. For example, the clustering algorithm 309 may score the search query with the usage metric for the cluster to which the search query 306 is assigned. The computing device 109 may be configured to predict a popularity of the search query and one or more other of the plurality of other search queries by ranking the search query and one or more other of the plurality of other search queries according to the respective predicted usage metric of the cluster. In some examples, the search query and one or more other of the plurality of other search queries is ranked from the highest predicted popularity to the lowest predicted popularity.

At 1020, the computing device 109 may determine a search result based on the search query. For example, the computing device 109 may conduct a search of a database of content items using the search query. The computing device 109 may comprise a simulation engine 126 to conduct the search. The simulation engine 126 may produce a user environment that comprises the content item(s) as well as other, non-target content items (e.g., the plurality of other content items). The simulation engine 126 may use the search query to produce the search result. The simulation engine 126 may use the one or more other of the plurality of other search queries to produce a plurality of other search results. For example, the simulation engine 126 may query the user environment (e.g., one or more databases of content items) using the search query 306. The simulation engine 126 may produce an output or search result 403 of the user environment. In some examples, the output or search result 403 comprises one or more content items identified during the search. The content items identified during the search may be any number of content items. The content items identified during the search may comprise the content item or not comprise the content item. The content items identified during the search may comprise one or more of the other plurality of content items. The content items identified during the search may be listed in a particular order. For example, the content items identified during the search may be listed in a best matching or highest percentage matching order, where the content item that is the best match is listed first and then other content items are listed based on matching or percentage matching order. The number of content items identified during the search may be limited based on a maximum number or based on the lowest best match or matching percentage that will be presented in the content items identified during the search. The content items identified during the search may be presented in a list format or may be presented by a representative thumbnail image. The content items identified during the search may further include their matching score or percentage based on the search query. The search result 403 may comprise an image of a user interface having the one or more content items identified during the search.

At 1030, the computing device 109 may determine a search result metric for the content item. For example, the search result metric may be based on the search result for the search query trying to identify the and determine the priority position for the content item that is not available or not yet available to at least a portion of the users as a search result. For example, the search result metric may indicate an accuracy of the search result based on the search query to identify the content item not available or not yet available for search to at least a portion of the users. For example, the search result metric may be based on one or more of the numerical position of the content item within the search result of content items identified during the search, the matching order of the content item in the search result of the content items identified during the search, and/or the matching percentage for the content item in the content items identified during the search of the search result.

For example, the search result for the search query may have the following content items identified during the search, with Content Item D being the content item that was being searched for based on the search query.

| Numerical Position | Matching % |
|---|---|
| 1. Content Item A | 88% |
| 2. Content Item B | 81% |
| 3. Content Item C | 69% |
| 4. Content Item D | 49% |
| 5. Content Item E | 41% |

For example, the search result metric for Content Item D may be one or more of numerical position of 4, 40% position rank (e.g., 1−(number of content items with better (e.g., closer to 1) numerical position/total content items listed)), and/or 49% matching percentage. For example, determining the search result metric may comprise determining a numerical position or rank of the content item within a plurality of content items in the search result of content items identified during the search.

The search result metric may be compared to a low search result threshold. For example, the search result metric may be compared to the low search result threshold to determine if modification to the metadata for the content item needs to be modified. For example, if the search result metric satisfies the low search result threshold (e.g., if the search result metric is the position rank or matching percentage then is less than or less than or equal to the low search result threshold while if the search result metric is the numerical position of the target content item then is greater than or greater than or equal to the low search result threshold) the system may determine to modify the metadata for or associated with the content item so that next time that particular search query is used, the content item will be at or closer to the number 1 numerical position, will have a higher position rank percentage, and/or will have a higher matching percentage. For example, if the search result metric satisfies the low search result threshold, it is an indication that the search, using the search query, did not identify the content item in the right way (e.g., it did not have a position rank at one or closer to 1, did not have a higher position rank percentage, and/or did not have a higher matching percentage).

The low search result threshold may be adjustable by a manager or user of the system. The low search result threshold may be a numerical position, a position rank, or a matching percentage. For example, the system may have an intended display layout for the search result of the content items identified during the search. For example, while the search, using the search query, may have five content items identified during the search, only the first two content items identified during the search may be on the initial page viewable to a user providing the search query. The other content items identified during the search may be viewed by scrolling down or to the side or selecting one or more next page options. In other examples, the number of content items identified during the search viewable on the first page may be more or less than two. In this scenario, it may be desirable for the content item to be within the first page of content items identified during the search. For example, the search result metric satisfying the low search result threshold may be an indicator that the content item will not be on the first or initial page of the search result of the content items identified during the search.

In another example, the search, using the search query, may have five content items identified during the search, all of which are presented on the initial page viewable to a user providing the search query. However, the eyes of users are typically drawn initially to the one or two content items identified during the search in the best (e.g., closest to 1) position. In this scenario, it may be desirable for the content item to be within at least one of those best positions so that it is more likely to be what is initially viewed by the viewer. For example, the search result metric satisfying the low search result threshold may be an indicator that the content item will not be in one of the best or priority positions for the search result of the content items identified during the search.

The computing device 109 may compare the search result metric to the low search result threshold. The computing device 109 may determine if the search result metric satisfies the low search result threshold. For example, if the low search result threshold is a position of 2 and the content item is at a position of 4, as shown above, the search result metric for position would be 4 for Content Item D, would be greater than the low search result threshold, and thereby satisfy the low search result threshold. For example, if the low search result threshold was a position rank of 60%, the search result metric for Content Item D would be 40%, which would be less than the low search result threshold, and thereby satisfy the low search result threshold. For example, if the low search result threshold was a matching percentage of 80%, the search result metric for Content Item D would be a matching percentage of 49%, which would be less than the low search result threshold, and thereby satisfy the low search result threshold. If the computing device determines that the search result metric for the content item does not satisfy the low search result threshold (e.g., the content item was sufficiently prioritized on the search result of content items identified during the search), the system may not modify the metadata of the content item. However, if the search result metric for the content item does satisfy the low search result threshold, the computing device 109 may determine to modify the metadata of the content item in an effort to improve how prioritized the content item is in a subsequent search using that particular search query.

Furthermore, the computing device 109 may comprise a discoverability engine 129 capable of determining, for the search query, a correspondence between the search result and the content item. The discoverability engine 129 may be configured to analyze the search result by comparing the one or more content items identified during the search in the search result to the content item. The discoverability engine 129 may determine that there is a correspondence between the content items identified during the search and the content item, or determine that there is not a correspondence between the content items identified during the search and the content item. For example, the discoverability engine 129 may determine that the content item is identified as one of the content items identified during the search, or that the content item is not identified as one of the content items identified during the search. For example, the discoverability engine 129 may determine a degree of correspondence by determining a position of the content item within the content items identified during the search and where that position is relative to the top of the search results. The discoverability engine 129 may further use the determination of the position of the content item to determine whether a modification is necessary.

At 1040, the computing device 109 may modify the metadata associated with the content item. For example, the computing device 109 may modify the metadata for the content item based on the search result metric for the content item. For example, the computing device 109 may modify the metadata for the content item based on the search result metric for the content item satisfying the low search result threshold. In some examples, the discoverability engine 129 may cause a remedial action (e.g., modifying the metadata for the content item) to be taken based on the determined correspondence and the usage metric 506 for the search query 306. For example, if the discoverability engine 129 determines that there is not a correspondence between the content items identified during the search and the content item at 640, the discoverability engine 129 may reference the usage metric 506 of the search query. In some examples, the discoverability engine 129 may compare the usage metric of the search query to a threshold to determine whether a remedial action is necessary. For example, if the discoverability engine 129 determines that the search query 306 meets or exceeds the threshold, a remedial action may be taken.

For example, if the discoverability engine 129 determines that the usage metric 506, usage rate, and/or frequency of use of the search query 306 is low or falls below a threshold, the discoverability engine 129 may determine that no remedial action is necessary. However, if the discoverability engine 129 determines that the usage metric 506 of the search query is high and the correspondence between the content items identified during the search and the content item is low or does not correspond, the discoverability engine 129 may determine that a remedial action is necessary.

The computing device 109 may determine to modify the metadata for the content item. The computing device 109, such as the discoverability engine 129, may compare the search query to the metadata for or associated with the content item. For examples, the discoverability engine 129 may determine that one or more words used in the search query are not included in the metadata for or associated with the content item. For example, the discoverability engine 129 may modify the metadata for or associated with the content item to comprise one or more of the words, such as key words, of the search query. In some examples, the metadata for or associated with the content item may be modified to comprise a marker, indicator, or other means intended to inflate the likelihood of the content item appearing as one of the higher priority (e.g., closer to 1 and greater than the low search result threshold, matching percentage greater than the low search result threshold, and/or position rank greater than the low search result threshold) content items identified during the search when the search query is used in a subsequent search. Other examples are possible as well.

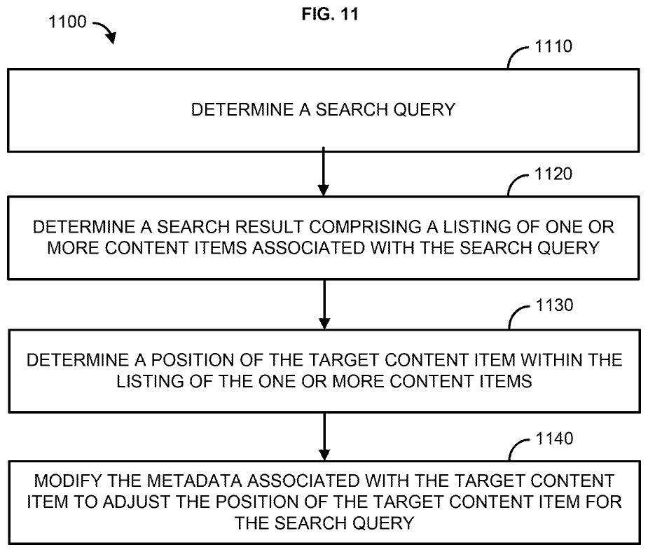

FIG. 11 shows a flowchart of an example method 1100. The method 1100 may be performed in whole or in part by a single computing device, a plurality of computing devices, and the like. For example, the method 1100 may be performed by the computing device or environment 109, a computing device in communication with the computing device or environment 109 or any other computing device described herein. For example, a portion of the method 1100 may be performed by a first computing device, while another portion of the method 1100 may be performed by another computing device. For ease of explanation, the method 1100 will be described as being performed by the computing device or environment 109.

At 1110, the computing device 109 may determine a search query for trying to retrieve, as a search result, the target content item, such as one of the search queries 306. For example, the target content item may not be available or not yet be available to be searched by all or at least a portion of the users of a search query system of a content provider. The search query may be identified to determine how well the search query, and potentially a plurality of other search queries, is at identifying, and prioritizing in a listing of a search result, the target content item in a database that comprises a plurality of other content items that may or may not be identified by the particular search query.

For example, the computing device 109 may generate the search query of the one of the search queries 306. For example, a search query generator 123 may determine and/or generate the search query 306 directed to trying to identify the target content item from a plurality of other content items using a search database for a particular content platform of a content provider 106. The search query generator 123 may generate the search query based on metadata from or associated with the target content item and/or one or more other of the other plurality of content items (e.g., content item metadata 206). For example, the metadata for or associated with content item may include the title of the content item, one or more actor's names, the genre for the content item, a brief summary of the content item. Any one or more of these or portions of these may be included in the search query. For example, the search query generator 123 may generate the search query 306 that comprises key words, or synonyms of key words, from the content item metadata 206. For example, the search query generator 123 may generate the search query based on historic query data, or historical user-generated search queries 203. For example, the search query generator 123 may use a machine-learning model to train the search query generator 123 on historical user-generated search queries 203 to generate the search query in the form or style of one or more of the historical user-generated search queries 203.

The computing device 109 may rank the search query against one or more of a plurality of other search queries 306. As described in the example of FIG. 3, the computing device 109 may comprise a clustering algorithm 309 for predicting a popularity of each search query 306. The clustering algorithm 309 and ranking process may rank the search query according to a predicted popularity by clustering a plurality of historic queries, or historical user-generated search queries 203. The clustering algorithm 309 may cluster the historical user-generated search queries 203 based on one or more structural similarities among the historical user-generated search queries 203. The clustering algorithm 309 may produce one or more clusters of historical user-generated search queries 203 to map or assign the search query and one or more other of the plurality of other search queries to a cluster of the one or more clusters. For example, the clustering algorithm 309 may cluster the historical user-generated search queries 203 into one or more clusters based on structural similarities and then map the search query and one or more other of the plurality of other search queries to a cluster because the structure of the particular search query is the same as or otherwise aligned with that of the historical user-generated search queries 203 in the cluster. The clustering algorithm 309 is further able to metric each cluster of the one or more clusters based on popularity data for the plurality of historical queries. For example, the historical user-generated search queries 203 of each cluster may be associated with various popularity data or historical search query metadata 303 which indicates the number of times a particular historical user-generated search query 203 was entered by a user for a search. The historical search query metadata 303 may be interpreted to assign a usage metric to the historical user-generated search query 203 and to determine an average usage metric for the cluster of historical user-generated search queries 203. The search query and one or more other of the plurality of other search queries 306 may be mapped to the one or more clusters by comparing the search query and one or more other of the plurality of other search queries 306 to the plurality of historical user-generated search queries 203 within each cluster and grouping the search query and one or more other of the plurality of other search queries in respective clusters according to structural similarities.

Based on mapping the search query and one or more other of the plurality of other search queries to the one or more clusters, the clustering algorithm 309 may determine a metric or rank for the search query against one or more other of the plurality of other search queries. For example, the clustering algorithm 309 may score the search query with the usage metric for the cluster to which the search query 306 is assigned. The computing device 109 may be configured to predict a popularity of the search query and one or more other of the plurality of other search queries by ranking the search query and one or more other of the plurality of other search queries according to the respective predicted usage metric of the cluster. In some examples, the search query and one or more other of the plurality of other search queries is ranked from the highest predicted popularity to the lowest predicted popularity.

At 1120, the computing device 109 may determine a search result based on the search query. For example, the computing device 109 may conduct a search of a database of content items using the search query. The computing device 109 may comprise a simulation engine 126 to conduct the search. The simulation engine 126 may produce a user environment that comprises the target content items as well as other, non-target content items (e.g., the plurality of other content items). The simulation engine 126 may use the search query to produce the search result. The simulation engine 126 may use the one or more other of the plurality of other search queries to produce a plurality of other search results. For example, the simulation engine 126 may query the user environment (e.g., such as one or more databases of content items) using the search query 306. The simulation engine 126 may produce an output or search result 403 of the user environment. In some examples, the output or search result 403 comprises one or more content items identified during the search. The content items identified during the search may be any number of content items. The content items identified during the search may comprise the target content item or not comprise the target content item. The content items identified during the search may comprise one or more of the other plurality of content items. The content items identified during the search may be listed in a particular order. For example, the content items identified during the search may be listed in a best matching or highest percentage matching order, where the content item that is the best match is listed first and then other content items are listed based on matching or percentage matching order. The number of content items identified during the search may be limited based on a maximum number or based on the lowest best match or matching percentage that will be presented in the content items identified during the search. The content items identified during the search may be presented in a list format or may be presented by a representative thumbnail image. The content items identified during the search may further include their matching score or percentage based on the search query. The search result may comprise an image of a user interface having the one or more content items identified during the search.

At 1130, the computing device 109 may determine a position of the target content item within a listing of the one or more content items in the content items identified during the search. For example, the position of the target content item within the listing of the one or more content items in the content items identified during the search may be based on the search result for the search query trying to identify the and determine the priority position for the target content item that is not available or not yet available to at least a portion of the users as a search result. For example, the position of the target content item within the listing of the one or more content items in the content items identified during the search may indicate an accuracy of the search result based on the search query to identify the target content item not available or not yet available for search to at least a portion of the users. For example, the position of the target content item may be based on the numerical position of the target content item within the search result of content items identified during the search.

For example, the search result for the search query may have the following content items identified during the search, with Content Item D being the target content item that was being searched for based on the search query.

### Numerical Position

1. Content Item A
2. Content Item B
3. Content Item C
4. Content Item D
5. Content Item E
   For example, the position for the target content item Content Item D may be the numerical position of 4. For example, determining the position of the target content item may comprise determining a numerical position of the target content item within a plurality of content items in the search result of content items identified during the search.

The position of the target content item may be compared to a low search result threshold. For example, the position of the target content item within the search result may be compared to the low search result threshold to determine if modification to the metadata for the target content item needs to be modified. For example, if the position of the target content item satisfies the low search result threshold (e.g., is greater than or greater than or equal to the low search result threshold) the computing device 109 may determine to modify the metadata for or associated with the content item so that next time that particular search query is used, the target content item will be at or closer to the number 1 numerical position in the search result of content items identified during the search. For example, if the position of the target content item satisfies the low search result threshold, it is an indication that the search, using the search query, did not identify the content item in the right way (e.g., it did not have a position at one or closer to one).

The low search result threshold may be adjustable by a manager or user of the system. The low search result threshold may be a numerical position, a position rank, or a matching percentage. For example, the system may have an intended display layout for the search result of the content items identified during the search. For example, while the search, using the search query, may have five content items identified during the search, only the first two content items identified during the search may be on the initial page viewable to a user providing the search query. The other content items identified during the search may be viewed by scrolling down or to the side or selecting one or more next page options. In other examples, the number of content items identified during the search viewable on the first page may be more or less than two. In this scenario, it may be desirable for the target content item to be within the first page of content items identified during the search. For example, the position of the target search result within the content items identified during the search satisfying the low search result threshold may be an indicator that the target content item will not be on the first or initial page of the search result of the content items identified during the search.

In another example, the search, using the search query, may have five content items identified during the search, all of which are presented on the initial page viewable to a user providing the search query. However, the eyes of users are typically drawn initially to the one or two content items identified during the search in the best (e.g., closest to 1) position. In this scenario, it may be desirable for the target content item to be within at least one of those best positions so that it is more likely to be what is initially viewed by the viewer. For example, the position of the target content item within the content items identified during the search satisfying the low search result threshold may be an indicator that the target content item will not be in one of the best or priority positions for the search result of the content items identified during the search.

The computing device 109 may compare the position of the target content item within the content items identified during the search of the search result to the low search result threshold. The computing device 109 may determine if the position of the target content item satisfies (e.g., is greater than or greater than or equal to) the low search result threshold. For example, if the low search result threshold is a position of 2 and the content item is at a position of 4, as shown above, the search result metric for position would be 4 for Content Item D, would be greater than the low search result threshold, and thereby satisfy the low search result threshold. If the computing device 109 determines that the position for the target content item does not satisfy the low search result threshold (e.g., the content item was sufficiently prioritized on the search result of content items identified during the search), the computing device 109 may not modify the metadata of the target content item. However, if the position for the target content item does satisfy the low search result threshold, the computing device 109 may determine to modify the metadata of the target content item in an effort to improve how prioritized the target content item is in a subsequent search using that particular search query.

Furthermore, the computing device 109 may comprise a discoverability engine 129 capable of determining, for the search query, a correspondence between the search result and the target content item. The discoverability engine 129 may be configured to analyze the search result by comparing the one or more content items identified during the search in the search result to the target content item. The discoverability engine 129 may determine that there is a correspondence between the content items identified during the search and the target content item, or determine that there is not a correspondence between the content items identified during the search and the target content item. For example, the discoverability engine 129 may determine that the target content item is identified as one of the content items identified during the search, or that the target content item is not identified as one of the content items identified during the search. For example, the discoverability engine 129 may determine a degree of correspondence by determining a position of the target content item within the content items identified during the search and where that position is relative to the top of the search results. The discoverability engine 129 may further use the determination of the position of the target content item to determine whether a modification is necessary.

At 1140, the computing device 109 may modify the metadata for or associated with the target content item. For example, the computing device 109 may modify the metadata for or associated with the target content item based on the position of the target content within the content items identified during the search of the search result based on the search query. For example, the computing device 109 may modify the metadata for the target content item based on the position of the target content item satisfying the low search result threshold. In some examples, the discoverability engine 129 may cause a remedial action (e.g., modifying the metadata for the target content item) to be taken based on the determined correspondence and the usage metric 506 for the search query 306. For example, if the discoverability engine 129 determines that there is not a correspondence between the content items identified during the search and the target content item at 1140, the discoverability engine 129 may reference the usage metric 506 of the search query. In some examples, the discoverability engine 129 may compare the usage metric of the search query to a threshold to determine whether a remedial action is necessary. For example, if the discoverability engine 129 determines that the search query meets or exceeds the threshold, a remedial action may be taken.

For example, if the discoverability engine 129 determines that the usage metric 506, usage rate, and/or frequency of use of the search query 306 is low or falls below a threshold, the discoverability engine 129 may determine that no remedial action is necessary. However, if the discoverability engine 129 determines that the usage metric 506 of the search query is high and the correspondence between the content items identified during the search and the target content item is low or does not correspond, the discoverability engine 129 may determine that a remedial action is necessary.

The computing device 109 may determine to modify the metadata for the target content item. The computing device 109, such as the discoverability engine 129, may compare the search query to the metadata for or associated with the target content item. For example, the discoverability engine 129 may determine that one or more words used in the search query are not included in the metadata for or associated with the target content item. For example, the discoverability engine 129 may modify the metadata for or associated with the target content item to comprise one or more of the words, such as key words, of the search query. In some examples, the metadata for or associated with the target content item may be modified to comprise a marker, indicator, or other means intended to inflate the likelihood of the target content item appearing as one of the higher priority positions (e.g., closer to 1 and greater than the low search result threshold) within the content items identified during the search when the search query is used in a subsequent search. Other examples are possible as well.

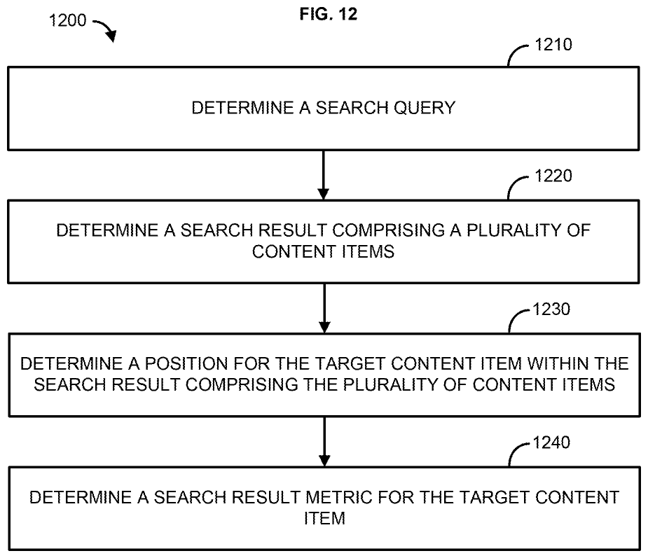

FIG. 12 shows a flowchart of an example method 1200. The method 1200 may be performed in whole or in part by a single computing device, a plurality of computing devices, and the like. For example, the method 1200 may be performed by the computing device or environment 109, a computing device in communication with the computing device or environment 109 or any other computing device described herein. For example, a portion of the method 1200 may be performed by a first computing device, while another portion of the method 1200 may be performed by another computing device. For ease of explanation, the method 1200 will be described as being performed by the computing device or environment 109.

At 1210, the computing device 109 may determine a search query for trying to retrieve, as a search result, the target content item, such as one of the search queries 306. For example, the target content item may not be available or not yet be available to be searched by all or at least a portion of the users of a search query system of a content provider. The search query may be identified to determine how well the search query, and potentially a plurality of other search queries, is at identifying, and prioritizing in a listing of a search result, the target content item in a database that comprises a plurality of other content items that may or may not be identified by the particular search query.

For example, the computing device 109 may generate the search query of the one of the search queries 306. For example, a search query generator 123 may determine and/or generate the search query 306 directed to trying to identify the target content item from a plurality of other content items using a search database for a particular content platform of a content provider 106. The search query generator 123 may generate the search query based on metadata from or associated with the target content item and/or one or more other of the other plurality of content items (e.g., content item metadata 206). For example, the metadata for or associated with content item may include the title of the content item, one or more actor's names, the genre for the content item, a brief summary of the content item. Any one or more of these or portions of these may be included in the search query. For example, the search query generator 123 may generate the search query 306 that comprises key words, or synonyms of key words, from the content item metadata 206. For example, the search query generator 123 may generate the search query based on historic query data, or historical user-generated search queries 203. For example, the search query generator 123 may use a machine-learning model to train the search query generator 123 on historical user-generated search queries 203 to generate the search query in the form or style of one or more of the historical user-generated search queries 203.

The computing device 109 may rank the search query against one or more of a plurality of other search queries 306. As described in the example of FIG. 3, the computing device 109 may comprise a clustering algorithm 309 for predicting a popularity of each search query 306. The clustering algorithm 309 and ranking process may rank the search query according to a predicted popularity by clustering a plurality of historic queries, or historical user-generated search queries 203. The clustering algorithm 309 may cluster the historical user-generated search queries 203 based on one or more structural similarities among the historical user-generated search queries 203. The clustering algorithm 309 may produce one or more clusters of historical user-generated search queries 203 to map or assign the search query and one or more other of the plurality of other search queries to a cluster of the one or more clusters. For example, the clustering algorithm 309 may cluster the historical user-generated search queries 203 into one or more clusters based on structural similarities and then map the search query and one or more other of the plurality of other search queries to a cluster because the structure of the particular search query is the same as or otherwise aligned with that of the historical user-generated search queries 203 in the cluster. The clustering algorithm 309 is further able to metric each cluster of the one or more clusters based on popularity data for the plurality of historical queries. For example, the historical user-generated search queries 203 of each cluster may be associated with various popularity data or historical search query metadata 303 which indicates the number of times a particular historical user-generated search query 203 was entered by a user for a search. The historical search query metadata 303 may be interpreted to assign a usage metric to the historical user-generated search query 203 and to determine an average usage metric for the cluster of historical user-generated search queries 203. The search query and one or more other of the plurality of other search queries 306 may be mapped to the one or more clusters by comparing the search query and one or more other of the plurality of other search queries 306 to the plurality of historical user-generated search queries 203 within each cluster and grouping the search query and one or more other of the plurality of other search queries in respective clusters according to structural similarities.

Based on mapping the search query and one or more other of the plurality of other search queries to the one or more clusters, the clustering algorithm 309 may determine a metric or rank for the search query against one or more other of the plurality of other search queries. For example, the clustering algorithm 309 may score the search query with the usage metric for the cluster to which the search query 306 is assigned. The computing device 109 may be configured to predict a popularity of the search query and one or more other of the plurality of other search queries by ranking the search query and one or more other of the plurality of other search queries according to the respective predicted usage metric of the cluster. In some examples, the search query and one or more other of the plurality of other search queries is ranked from the highest predicted popularity to the lowest predicted popularity.

At 1220, the computing device 109 may determine a search result comprising a plurality of content items. For example, the computing device 109 may determine the search result based on the search query. For example, the computing device 109 may conduct a search of a database of content items using the search query. The computing device 109 may comprise a simulation engine 126 to conduct the search. The simulation engine 126 may produce a user environment that comprises the target content items as well as other, non-target content items (e.g., the plurality of other content items). The simulation engine 126 may use the search query to produce the search result. The simulation engine 126 may use the one or more other of the plurality of other search queries to produce a plurality of other search results. For example, the simulation engine 126 may query the user environment (e.g., such as one or more databases of content items) using the search query 306. The simulation engine 126 may produce an output or search result 403 of the user environment comprising the plurality of content items. In some examples, the output or search result 403 comprises the plurality of content items identified during the search. The plurality of content items identified during the search may be any number of content items. The plurality of content items identified during the search may comprise the target content item or not comprise the target content item. The plurality of content items identified during the search may comprise one or more of the other plurality of content items. The plurality of content items identified during the search may be listed in a particular order. For example, the plurality of content items identified during the search may be listed in a best matching or highest percentage matching order, where the content item that is the best match is listed first and then other content items are listed based on matching or percentage matching order. The number of content items actually shown or displayed, as opposed to simply being identified, during the search may be limited based on available space, a maximum number, or based on the lowest best match or matching percentage that will be presented or displayed in the plurality of content items identified during the search. The plurality of content items identified during the search may be presented in a list format or may be presented by a representative thumbnail image horizontally, vertically, or in a matrix formation. The plurality of content items identified during the search may further include their matching score or percentage based on the search query. The search result may comprise an image of a user interface having the one or more of the plurality of content items identified during the search.

At 1230, the computing device 109 may determine a position of the target content item within a listing of the one or more content items in the content items identified during the search. For example, the position of the target content item within the listing of the one or more content items in the content items identified during the search may be based on the search result for the search query trying to identify the and determine the priority position for the target content item that is not available or not yet available to at least a portion of the users as a search result. For example, the position of the target content item within the listing of the one or more content items in the content items identified during the search may indicate an accuracy of the search result based on the search query to identify the target content item not available or not yet available for search to at least a portion of the users. For example, the position of the target content item may be based on the numerical position of the target content item within the search result of content items identified during the search.

For example, the search result for the search query may have the following content items identified during the search, with Content Item D being the target content item that was being searched for based on the search query.

### Numerical Position

1. Content Item A
2. Content Item B
3. Content Item C
4. Content Item D
5. Content Item E
   For example, the position for the target content item Content Item D may be the numerical position of 4. For example, determining the position of the target content item may comprise determining a numerical position of the target content item within a plurality of content items in the search result of content items identified during the search.

At 1240, a search result metric for the target content item may be determined. For example, the search result metric may be determined by the computing device 109. For example, the search result metric may be based on the search result for the search query trying to identify the and determine the priority position for the content item that is not available or not yet available to at least a portion of the users as a search result. For example, the search result metric may indicate an accuracy of the search result based on the search query to identify the content item not available or not yet available for search to at least a portion of the users. For example, the search result metric may be based on one or more of the numerical position of the content item within the search result of content items identified during the search, the matching order of the content item in the search result of the content items identified during the search, and/or the matching percentage for the content item in the content items identified during the search of the search result.

For example, as described above, the search result for the search query may have the following content items identified during the search, with Content Item D being the content item that was being searched for based on the search query.

| Numerical Position | Matching % |
|---|---|
| 1. Content Item A | 88% |
| 2. Content Item B | 81% |
| 3. Content Item C | 69% |
| 4. Content Item D | 49% |
| 5. Content Item E | 41% |

For example, the search result metric for Content Item D may be one or more of numerical position of 4, 40% position rank (e.g., 1−(number of content items with better (e.g., closer to 1) numerical position/total content items listed)), and/or 49% matching percentage. For example, determining the search result metric may comprise determining a numerical position or rank of the content item within a plurality of content items in the search result of content items identified during the search.

The search result metric may be compared to a low search result threshold. For example, the search result metric may be compared to the low search result threshold to determine if modification to the metadata for the content item needs to be modified. For example, if the search result metric satisfies the low search result threshold (e.g., if the search result metric is the position rank or matching percentage then is less than or less than or equal to the low search result threshold while if the search result metric is the numerical position of the target content item then is greater than or greater than or equal to the low search result threshold) the system may determine to modify the metadata for or associated with the content item so that next time that particular search query is used, the content item will be at or closer to the number 1 numerical position, will have a higher position rank percentage, and/or will have a higher matching percentage. For example, if the search result metric satisfies the low search result threshold, it is an indication that the search, using the search query, did not identify the content item in the right way (e.g., it did not have a position rank at one or closer to 1, did not have a higher position rank percentage, and/or did not have a higher matching percentage).

The low search result threshold may be adjustable by a manager or user of the system. The low search result threshold may be a numerical position, a position rank, or a matching percentage. For example, the system may have an intended display layout for the search result of the content items identified during the search. For example, while the search, using the search query, may have five content items identified during the search, only the first two content items identified during the search may be on the initial page viewable to a user providing the search query. The other content items identified during the search may be viewed by scrolling down or to the side or selecting one or more next page options. In other examples, the number of content items identified during the search viewable on the first page may be more or less than two. In this scenario, it may be desirable for the content item to be within the first page of content items identified during the search. For example, the search result metric satisfying the low search result threshold may be an indicator that the content item will not be on the first or initial page of the search result of the content items identified during the search.

In another example, the search, using the search query, may have five content items identified during the search, all of which are presented on the initial page viewable to a user providing the search query. However, the eyes of users are typically drawn initially to the one or two content items identified during the search in the best (e.g., closest to 1) position. In this scenario, it may be desirable for the content item to be within at least one of those best positions so that it is more likely to be what is initially viewed by the viewer. For example, the search result metric satisfying the low search result threshold may be an indicator that the content item will not be in one of the best or priority positions for the search result of the content items identified during the search.

The computing device 109 may compare the search result metric to the low search result threshold. The computing device 109 may determine if the search result metric satisfies the low search result threshold. For example, if the low search result threshold is a position of 2 and the content item is at a position of 4, as shown above, the search result metric for position would be 4 for Content Item D, would be greater than the low search result threshold, and thereby satisfy the low search result threshold. For example, if the low search result threshold was a position rank of 60%, the search result metric for Content Item D would be 40%, which would be less than the low search result threshold, and thereby satisfy the low search result threshold. For example, if the low search result threshold was a matching percentage of 80%, the search result metric for Content Item D would be a matching percentage of 49%, which would be less than the low search result threshold, and thereby satisfy the low search result threshold. If the computing device determines that the search result metric for the content item does not satisfy the low search result threshold (e.g., the content item was sufficiently prioritized on the search result of content items identified during the search), the system may not modify the metadata of the content item. However, if the search result metric for the content item does satisfy the low search result threshold, the computing device 109 may determine to modify the metadata of the content item in an effort to improve how prioritized the content item is in a subsequent search using that particular search query.

Furthermore, the computing device 109 may comprise a discoverability engine 129 capable of determining, for the search query, a correspondence between the search result and the content item. The discoverability engine 129 may be configured to analyze the search result by comparing the one or more content items identified during the search in the search result to the content item. The discoverability engine 129 may determine that there is a correspondence between the content items identified during the search and the content item, or determine that there is not a correspondence between the content items identified during the search and the content item. For example, the discoverability engine 129 may determine that the content item is identified as one of the content items identified during the search, or that the content item is not identified as one of the content items identified during the search. For example, the discoverability engine 129 may determine a degree of correspondence by determining a position of the content item within the content items identified during the search and where that position is relative to the top of the search results. The discoverability engine 129 may further use the determination of the position of the content item to determine whether a modification is necessary.

The computing device 109 may modify the metadata associated with the content item. For example, the computing device 109 may modify the metadata for the content item based on the search result metric for the content item. For example, the computing device 109 may modify the metadata for the content item based on the search result metric for the content item satisfying the low search result threshold. In some examples, the discoverability engine 129 may cause a remedial action (e.g., modifying the metadata for the content item) to be taken based on the determined correspondence and the usage metric 506 for the search query 306. For example, if the discoverability engine 129 determines that there is not a correspondence between the content items identified during the search and the content item at 640, the discoverability engine 129 may reference the usage metric 506 of the search query. In some examples, the discoverability engine 129 may compare the usage metric of the search query to a threshold to determine whether a remedial action is necessary. For example, if the discoverability engine 129 determines that the search query 306 meets or exceeds the threshold, a remedial action may be taken.

For example, if the discoverability engine 129 determines that the usage metric 506, usage rate, and/or frequency of use of the search query 306 is low or falls below a threshold, the discoverability engine 129 may determine that no remedial action is necessary. However, if the discoverability engine 129 determines that the usage metric 506 of the search query is high and the correspondence between the content items identified during the search and the content item is low or does not correspond, the discoverability engine 129 may determine that a remedial action is necessary.

The computing device 109 may determine to modify the metadata for the content item. The computing device 109, such as the discoverability engine 129, may compare the search query to the metadata for or associated with the content item. For examples, the discoverability engine 129 may determine that one or more words used in the search query are not included in the metadata for or associated with the content item. For example, the discoverability engine 129 may modify the metadata for or associated with the content item to comprise one or more of the words, such as key words, of the search query. In some examples, the metadata for or associated with the content item may be modified to comprise a marker, indicator, or other means intended to inflate the likelihood of the content item appearing as one of the higher priority (e.g., closer to 1 and greater than the low search result threshold, matching percentage greater than the low search result threshold, and/or position rank greater than the low search result threshold) content items identified during the search when the search query is used in a subsequent search. Other examples are possible as well.

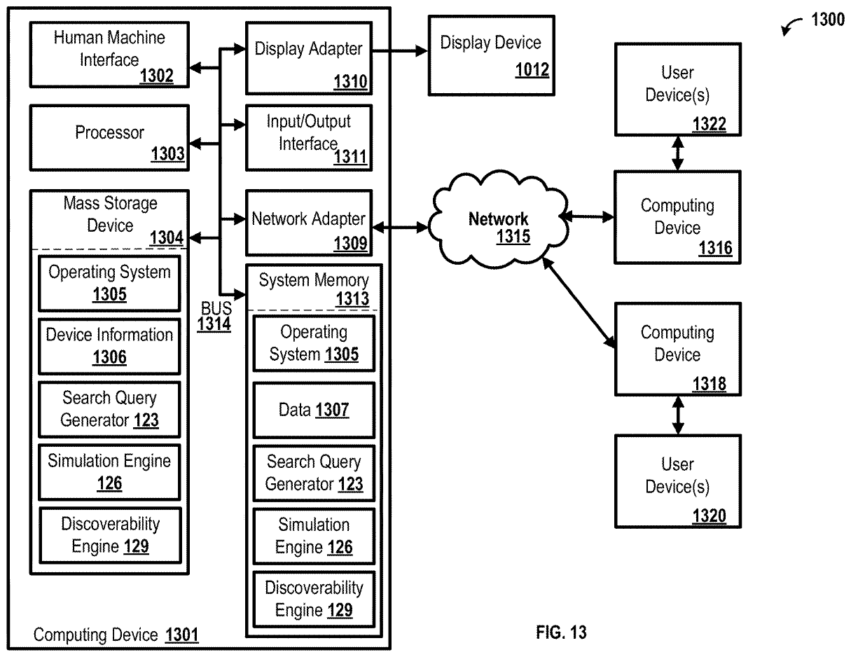

FIG. 13 shows a block diagram of an example system 1300 and computing device 1301 (e.g., computer) for managing channel frequency overlap. Any device/component described herein (e.g., the computing device 109, the search query generator 123, the simulation engine 126, the discoverability engine 129, and/or the content providers 106) may be the computing device 1301 as shown in FIG. 13.

The computing device 1301 may comprise one or more processors 1303, a system memory 1313, and a bus 1314 that couples various components of the computing device 1301 including the one or more processors 1303 to the system memory 1313. In the case of multiple processors 1303, the computing device 1301 may utilize parallel computing.

The bus 1314 may comprise one or more of several possible types of bus structures, such as a memory bus, memory controller, a peripheral bus, an accelerated graphics port, and a processor or local bus using any of a variety of bus architectures.

The computing device 1301 may operate on and/or include a variety of computer-readable media (e.g., non-transitory). Computer-readable media may be any available media that is accessible by the computing device 1301 and includes non-transitory, volatile and/or non-volatile media, removable and non-removable media. The system memory 1313 has computer-readable media in the form of volatile memory, such as random access memory (RAM), and/or non-volatile memory, such as read-only memory (ROM). The system memory 1313 may store data such as data 1307 and/or program modules such as an operating system 1305 that are accessible to and/or are operated on by the one or more processors 1303. The data 1307 may comprise information such as historical user-generated search queries 203, content item metadata 206, historical search query metadata 303, search queries 306, search results 403, and other various data which may be received, generated, used, and/or stored by the applications of the computing device 1301.

The computing device 1301 may also include other removable/non-removable, volatile/non-volatile computer storage media. The mass storage device 1304 may provide non-volatile storage of computer code, computer-readable instructions, data structures, program modules, and other data for the computing device 1301. The mass storage device 1304 may be a hard disk, a removable magnetic disk, a removable optical disk, magnetic cassettes or other magnetic storage devices, flash memory cards, CD-ROM, digital versatile disks (DVD) or other optical storage, random access memories (RAM), read-only memories (ROM), electrically erasable programmable read-only memory (EEPROM), and the like.

Any number of program modules may be stored on the mass storage device 1304. For example, an operating system 1305 and functionality for the search query generator 123, the simulation engine 126, and the discoverability engine 129 may be stored on the mass storage device 1304. Device information 1306 may also be stored on the mass storage device 1304. The device information 1306 may comprise identifiers for other computing devices (e.g., other network devices, such as access points, gateways, and/or routers), and wireless network information associated with those other computing devices, such as the computing devices 1316, 1318. The device information 1306 may be stored in any of one or more databases known in the art. The databases may be centralized or distributed across multiple locations within the network 1315.

A user may enter commands and information into the computing device 1301 via an input device (not shown). Such input devices comprise, but are not limited to, a keyboard, pointing device (e.g., a computer mouse, remote control), a microphone, a joystick, a scanner, tactile input devices such as gloves, and other body coverings, motion sensor, and the like. These and other input devices may be connected to the one or more processors 1303 via a human machine interface 1302 that is coupled to the bus 1314, but may be connected by other interface and bus structures, such as a parallel port, game port, an IEEE 1394 Port (also known as a Firewire port), a serial port, network adapter 1309, and/or a universal serial bus (USB).

A display device 1312 may also be connected to the bus 1314 via an interface, such as a display adapter 1310. It is contemplated that the computing device 1301 may have more than one display adapter 1310 and the computing device 1301 may have more than one display device 1312. A display device 1312 may be a monitor, an LCD (Liquid Crystal Display), light-emitting diode (LED) display, television, smart lens, smart glass, and/or a projector. In addition to the display device 1312, other output peripheral devices may comprise components such as speakers (not shown) and a printer (not shown) which may be connected to the computing device 1301 via Input/Output Interface 1311. Any step and/or result of the methods may be output (or caused to be output) in any form to an output device. Such output may be any form of visual representation, including, but not limited to, textual, graphical, animation, audio, tactile, and the like. The display device 1312 and computing device 1301 may be part of one device, or separate devices.

The computing device 1301 may operate in a networked environment using logical connections to one or more remote computing devices 1316, 1318. The remote computing devices 1316, 1318 may correspond to any one of the computing device 109 or the content providers 106 of FIG. 1 and may comprise one or more of an access point, router, and/or gateway. Each remote computing device 1316, 1318 may be in wireless communication with one or more user devices, such as user devices 1320, 1322. The user devices 1320, 1322 may correspond to any user device and may comprise one or more of a mesh extender, subordinate device, augmented reality device, virtual reality device, personal computer, computing station (e.g., workstation), portable computer (e.g., laptop, mobile phone, smart phone tablet computer), smart television, set-top-box, smart device (e.g., smartphone, smartwatch, activity tracker, smart apparel, smart accessory), an IoT device, a thermostat, a home appliance or other common network nodes. Logical connections between the computing device 1301 and the computing devices 1316, 1318 may be made via one or more of a local network devices, a remote network device, and/or a network 1315, such as a local area network (LAN) and/or a general wide area network (WAN). Such network connections with the computing device 1301 may be through a network adapter 1309. The network adapter 1309 may be implemented in both wired and wireless environments. Such networking environments are conventional and commonplace in dwellings, offices, enterprise-wide computer networks, intranets, and the Internet.

Application programs and other executable program components such as the operating system 1305 and the search query engine 123, the simulation engine 126, and the discoverability engine 129 functionality are shown herein as discrete blocks, although it is recognized that such programs and components may reside at various times in different storage components of the computing device 1301, and are executed by the one or more processors 1303 of the computing device 1301. An implementation of the functionality of the search query engine 123, the simulation engine 126, and the discoverability engine 129 may be stored on or sent across some form of computer-readable media. Any of the disclosed methods may be performed by processor-executable instructions embodied on computer-readable media.

Computer readable media may be any available media that may be accessed by a computer. By way of example and not meant to be limiting, computer readable media may comprise “computer storage media” and “communications media.” “Computer storage media” may comprise volatile and non-volatile, removable and non-removable media implemented in any methods or technology for storage of information such as computer readable instructions, data structures, program modules, or other data. Exemplary computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

While specific configurations have been described, it is not intended that the scope be limited to the particular configurations set forth, as the configurations herein are intended in all respects to be possible configurations rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

What is claimed is:

1. A method comprising:
determining, based on a content item not available to at least a portion of users, a search query for the content item;
determining, based on the search query, a search result associated with the content item;
determining, based on the search result for the search query, a search result metric;
modifying, based on the search result metric, the metadata associated with the content item.

2. The method of claim 1, further comprising:
ranking the search query according to the predicted frequency of use associated with the search query; and
conducting, based on the search query, a search.

3. The method of claim 1, further comprising determining the search result metric satisfies a low search result threshold, wherein modifying, based on the search result metric, the metadata associated with the content item comprises modifying, based on the search result metric satisfying the low search result threshold, the metadata associated with the content item.

4. The method of claim 1, further comprising:
determining, based on one or more structural similarities among a plurality of historical user-generated search queries, one or more clusters of search queries for the plurality of historical user-generated search queries; and
determining, based on frequency of use data for the plurality of historical user-generated search queries, a frequency of use metric for each of the one or more clusters of search queries.

5. The method of claim 4, wherein ranking the search query according to the predicted frequency of use further comprises:
assigning each search query of the plurality of search queries to a cluster of the one or more clusters of search queries; and
determining, based on an assigned cluster for the search query, the frequency of use metric for the search query.

6. The method of claim 1, wherein the search result metric indicates an accuracy of the search result based on the search query.

7. The method of claim 1, wherein determining the search result further comprises:
conducting, based on a search query, a query of a user environment, wherein the user environment comprises a plurality of content items comprising the content item; and
receiving, based on the search query, a search result comprising one or more content items identified during the search.

8. The method of claim 1, wherein determining, for the search query, the search result metric further comprises determining a numerical position of the content item within a plurality of content items in the search result.

9. The method of claim 1, wherein modifying the metadata associated with the content item further comprises:
determining one or more words of the search query; and
modifying, based on the one or more words of the search query, the metadata associated with the content item to include one or more of the one or more words of the search query.

10. A method comprising:
determining, based on a target content item not available to at least a portion of users, a search query;
determining, based on the search query, a search result, the search result comprising a listing of one or more content items associated with the search query;
determining, based on the search result, a position of the target content item within the listing of the one or more content items; and
modifying, based on the position of the target content item, the metadata associated with the target content item to adjust the position of the target content item for the search query.

11. The method of claim 10, further comprising determining the position of the target content time satisfies a position threshold, wherein modifying, based on the position of the target content item the metadata associated with the target content item comprises modifying, based on the position of the target content item satisfying the position threshold, the metadata associated with the target content item.

12. The method of claim 10, further comprising:
ranking the search query against a plurality of search queries according to the predicted usage rate for the search query and the plurality of search queries; and
conducting, based on the search query, a search of content items.

13. The method of claim 10, further comprising:
determining, based on one or more structural similarities among a plurality of historical user-generated search queries, cluster of search queries for the search query; and
determining, based on usage data for the plurality of historical user-generated search queries, a usage rate for the cluster of search queries.

14. The method of claim 13, wherein ranking the search query further comprises:
assigning the search query to a cluster of the one or more clusters; and
determining, based on the assigned cluster, a rank for the search query.

15. The method of claim 10, wherein determining the search result further comprises querying a user environment using the search query, wherein the user environment comprises the target content item and a plurality of additional content items.

16. The method of claim 8, wherein modifying the metadata associated with target content item comprises adding one or more words of the search query into the metadata of the target content item.

17. A method comprising:
determining, based on metadata associated with a target content item not available to at least a portion of users, a search query;
determining, based on the search query, a search result comprising a plurality of content items;
determining, based on the search result, a position for the target content item within the search result comprising the plurality of content items; and
determining, based on the position for the target content item in the search result, a search result metric for the target content item.

18. The method of claim 17, further comprising determining a usage rate for the search query.

19. The method of claim 17, further comprising modifying, based on the search result metric, metadata for the target content item.

20. The method of claim 17, further comprising:
determining a plurality of search result metrics for a plurality of additional search queries and corresponding search results; and
determining, based on the plurality of search result metrics and a determined usage rate for each search query of the plurality of search queries, a discoverability metric for the target content item.
